(19) United States
(12) Patent Application Publication
(10) Pub. No.: US 2014/0009463 A1
(43) Pub. Date: Jan. 9, 2014

(54) IMAGE DISPLAY DEVICE

(71) Applicant: Panasonic Corporation, Osaka (JP)

(72) Inventors: Tatsumi WATANABE, Osaka (JP); Ken MASHITANI, Osaka (JP); Nobuyuki KUNIEDA, Osaka (JP)

(21) Appl. No.: 13/933,550

(22) Filed: Jul. 2, 2013

(30) Foreign Application Priority Data
Jul. 9, 2012 (JP) 2012-154075

(51) Int. Cl. G09G 5/14

(52) U.S. Cl. CPC G09G 5/14
USPC 345/419

(57) ABSTRACT

A parallax composite image displayed by image display means is separated by image separating means so that parallax images are observed at a predetermined position. Parallax images are alternately arranged for each of image rows in the parallax composite image. If the separating means has an inclination angle between 10 and 15 degrees and if a center of the separating means and a center of a pixel exist at a predetermined interval, crosstalk may be suppressed and a proper viewing distance may be shortened. By providing the image separating means with a notched structure of which aperture width periodically varies, adding irregularities to an aperture edge, and controlling an amount of blur of pixels observed through the aperture or alike, moiré reduction may be achieved.

### CROSS-REFERENCE TO RELATED APPLICATIONS

This application is based on Japanese Patent Application No. 2012-154075 filed on Jul. 9, 2012, the contents of which are hereby incorporated by reference.

### BACKGROUND OF THE INVENTION

1. Field of the Invention

The present invention relates to an image display apparatus configured to allow a stereoscopic image observed without special eyeglasses.

2. Description of the Related Art

With regard to devices for displaying stereoscopic images without special eyeglasses, a device is known as a prior art in which a parallax barrier, a lenticular lens or alike (spectroscopic means) is arranged on the observer side of a display device such as a liquid crystal panel or a plasma display panel (PDP) to separate light from left-eye and right-eye images displayed on a display panel to the left and right in order to display a stereoscopic image.

FIG. 30 shows principles of an eyeglass-free stereoscopic image display device which uses a parallax barrier. In the drawing, the reference numeral 1 denotes an image display panel and 2 denotes a parallax barrier. Rows in which left eye pixels L are aligned in the vertical direction and rows in which right eye pixels R are aligned in the vertical direction are alternately formed on the image display panel (“Autostereoscopic 3D Displays using Image-Splitter Method”, Journal of The Institute of Image Information and Television Engineers, Vol. 51, No. 7, pp. 1070-1078, (1997)). A large number of slit apertures 2a extending in the vertical direction are formed in the parallax barrier 2. Light blocking portions 2b extending in the vertical direction are formed between the respective apertures 2a. It should be noted that sufficient binocular parallax for a person to perceive a stereoscopic image exists between a left eye image that is constituted by the left eye pixels L and a right eye image that is constituted by the right eye pixels. An observer who wants to observe a stereoscopic image may perceive a stereoscopic image by positioning the head at a predetermined position (stereoscopic position) so that a left eye image 3L enters the left eye 4L through the aperture 2a and a right eye image 3R enters the right eye 4R through the aperture 2a. Meanwhile, light of the right eye image is blocked by the light blocking portion 2b not to enter the left eye 4L whereas light of the left eye image is blocked by the light blocking portion 2b not to enter the right eye 4R. A general system in which parallax images are alternately arranged every image row and observed through separating means, like the aforementioned device, is exemplified as the first prior art example.

FIG. 31 shows another prior art example. In FIG. 31, a display panel constituting a display screen 9 is a liquid crystal panel for color image display on which R pixels 1R for displaying red images, G pixels 1G for displaying green images, and B pixels 1B for displaying blue images are aligned in the stripe shaped pattern in the vertical direction. An R pixel 1R, a G pixel 1G and a B pixel 1B are sequentially arranged as shown in FIG. 31 when viewed in the horizontal direction. 1R, 1G and 1B, which are adjacent to each other, constitute a single left-eye pixel group 12L or a single right-eye pixel group 12R. In other words, each of the single left-eye pixel group 12L and the single right-eye pixel group 12R is as wide as three pixels. The left-eye and right-eye pixel groups 12L, 12R are alternately arranged. The three pixels constituting the single left-eye or right-eye pixel group 12L, 12R are arranged in an order of 1R, 1G and 1B from the right to the left from an observer. A parallax barrier 11 is arranged in front of the display screen 9 so that an observer at a proper viewing position for preferable observation of stereoscopic images perceives a stereoscopic image due to binocular parallax by observing a left-eye pixel group 12L through an aperture 11a of the parallax barrier 11 by the left eye 10L and a right-eye pixel group 12R through the aperture 11a by the right eye 10R. Meanwhile, the left eye 10L of the observer is prevented from observing the right-eye pixel group 12R by a light-blocking portion 11b of the parallax barrier 11 whereas the right eye 10R is prevented from observing the left-eye pixel group 12L by the light-blocking portion 11b. With regard to such a stereoscopic image display device, since a pitch P of the left-eye and right-eye pixel groups 12L, 12R corresponds to three pixels which is three times as long as the aforementioned first prior art example, a proper viewing distance is reduced to ⅓ times as long as the first prior art example (JP 3,634,486 B).

However, with regard to the first prior art example, in which parallax images are alternately arranged in sub-pixels per an image row, it has been pointed out that there is a problem of a longer distance (a proper distance) from a display screen to an observer to allow preferable observation for the observer if a sub-pixel size is small and if a distance is consistent from a display panel and an image separating means. In particular, this problem is unfavorable for a mobile application such as a tablet. It has also been pointed out that interference fringes (moiré), which are created between a pattern of the parallax barrier and a pixel pattern of a plasma display, have to be eliminated. Widening an aperture in order to reduce such moiré may increase crosstalk.

In the case of JP 3,634,486 B, the proper viewing distance is reduced to ⅓ times as long as the aforementioned first prior art example. Color moiré is, however, likely to occur near switching positions of parallax images. FIG. 32 shows a parallax image arrangement example with a vertical striped barrier. Three sub-pixels (i.e. one pixel) correspond to one pixel in one parallax image. FIG. 33 schematically shows a situation where the head moves slightly. When the head moves slightly to the left, color moiré is more likely to happen since an R pixel of an adjacent viewpoint becomes visible first from any barrier position in the vertical direction as depicted in a dotted frame. Likewise, this problem occurs when a slant barrier is used so as to maintain an aspect ratio of a parallax image. Other methods for reducing moiré or crosstalk themselves are required. A method of widening an aperture width or alike problematically increases crosstalk although moiré contrast is reduced, like the first prior art example.

### SUMMARY OF THE INVENTION

An image display device according to one aspect of the present invention provides stereoscopic image display in which parallax images are alternately arranged in sub-pixel units per two image rows. The image display device has a slant barrier aperture with an inclination of 3:2. The first invention is configured so that an amount/range of blur of pixels observed through a barrier is controllable by providing a barrier pattern with a fine notched structure so that an aperture width periodically varies to be horizontally symmetrical and by adding irregularities to an aperture edge.

According to the aforementioned image display device, by alternately arranging parallax images in sub-pixel units per two image rows, a proper viewing distance may be shortened and moiré may be reduced by widening an aperture up to a width corresponding to two sub-pixels. By providing a barrier pattern with a fine notched structure so that an aperture width periodically varies so as to be horizontally symmetrical, an average aperture ratio may be suppressed and moiré reduction may be achieved without increased crosstalk.

The above and other objects, features, and advantages of the present invention will become more apparent from reading of the following detailed description taken in connection with the accompanying drawings.

### BRIEF DESCRIPTION OF THE DRAWINGS

FIG. 1 shows a configuration of an image display device as the first invention according to the present invention;

FIG. 2 is a schematic view showing a conventional example where parallax images are alternately arranged in sub-pixel units per an image row, and a slant barrier aperture with an inclination of 3:1;

FIG. 3 is a schematic view showing a pixel arrangement example 1 where parallax images of the image display device as the first invention according to the present invention are alternately arranged in sub-pixel units per two image rows, and a slant barrier aperture 1 with an inclination of 3:2;

FIG. 4 is a schematic view showing how an adjacent pixel becomes observed through the slant barrier aperture 1 when the head is moved with respect to the image display device as the first invention according to the present invention;

FIG. 5 is a schematic view of a pixel arrangement example 1 where parallax images of an image display device as a first alternative invention according to the present invention are alternately arranged in sub-pixel units per two image rows, and a step barrier aperture 2 with an inclination of 3:2;

FIG. 6 is a schematic view showing how an adjacent pixel becomes observed through the step barrier aperture 2 when the head is moved with respect to the image display device as the first alternative invention according to the present invention;

FIG. 7 is a schematic view showing the pixel arrangement example 1 where parallax images of the image display device as the first invention according to the present invention is alternately arranged in sub-pixel units per two image rows, and a barrier aperture 3 which has an inclination of 3:2 and irregularities added to an aperture edge;

FIG. 8 is a schematic view showing a barrier pattern having a notched structure of the image display device as the first invention according to the present invention;

FIG. 9 is a schematic view showing moiré reduction by means of the notched structure of the image display device as the first invention according to the present invention;

FIG. 10 is a schematic view showing a pixel arrangement example 2 where parallax images of an image display device as the second invention according to the present invention are alternately arranged in sub-pixel units per two image rows, and a slant barrier aperture 4 with an inclination of 3:1;

FIG. 11 is a schematic view showing how an adjacent pixel becomes observed through the slant barrier aperture 4 when the head is moved with respect to the image display device as the second invention according to the present invention;

FIG. 12 is a schematic view showing a pixel arrangement example 2 where parallax images of the image display device as the second invention according to the present invention are alternately arranged in sub-pixel units per two image rows, and a barrier aperture 5 which has an inclination of 3:1 and irregularities added to an aperture edge;

FIG. 13 is a schematic view showing the pixel arrangement example 2 where parallax images of the image display device as the second invention according to the present invention are alternately arranged in sub-pixel units per two image rows, and a slant barrier aperture 6 with an inclination of 3:1;

FIG. 14 is a schematic view showing how an adjacent pixel becomes observed through the barrier aperture 6 when the head is moved with respect to the image display device as the second invention according to the present invention;

FIG. 15 is a schematic view showing the pixel arrangement example 2 where parallax images of the image display device as the second invention according to the present invention are alternately arranged in sub-pixel units per two image rows, and a barrier aperture 7 which has an inclination of 3:1 and irregularities added to an aperture edge;

FIG. 16 is a schematic view showing the pixel arrangement example 2 where parallax images of the image display device as the second invention according to the present invention are alternately arranged in sub-pixel units per two image rows, and a barrier aperture 8 which has an inclination of 3:1 and horizontally asymmetrical irregularities added to an aperture edge;

FIG. 17 is a schematic view showing a more versatile notched structure of the image display device as the second invention according to the present invention;

FIG. 18 shows a configuration of an image display device as the third invention according to the present invention;

FIG. 19 shows a configuration of a head detecting means of the image display device as the third invention according to the present invention;

FIG. 20 is a schematic view showing processes performed by a position detecting means of the image display device as the third invention according to the present invention;

FIG. 21 is a schematic view showing processes performed by the position detecting means of the stereoscopic image display device as the third invention according to the present invention;

FIG. 22 is a schematic view showing processes performed by a pattern matching unit of the position detecting means of the stereoscopic image display device as the third invention according to the present invention;

FIG. 23 is a schematic view showing a change in viewpoint pixel combinations in the image display device as the third invention according to the present invention;

FIG. 24 is a schematic view 2 showing a change in viewpoint pixel combinations in the image display device as the third invention according to the present invention;

FIG. 25 is a schematic view 3 showing a change in viewpoint pixel combinations in the image display device as the third invention according to the present invention;

FIG. 26 shows a configuration of an image display device as the fourth invention according to the present invention;

FIG. 27 shows a configuration of a control information determining means of the image display device as the fourth invention according to the present invention;

FIG. 28 is a schematic view showing barrier adjustment of the image display device as the fourth invention according to the present invention;

FIG. 29 shows examples of moiré patterns created by a conventional step barrier and a conventional slant barrier;

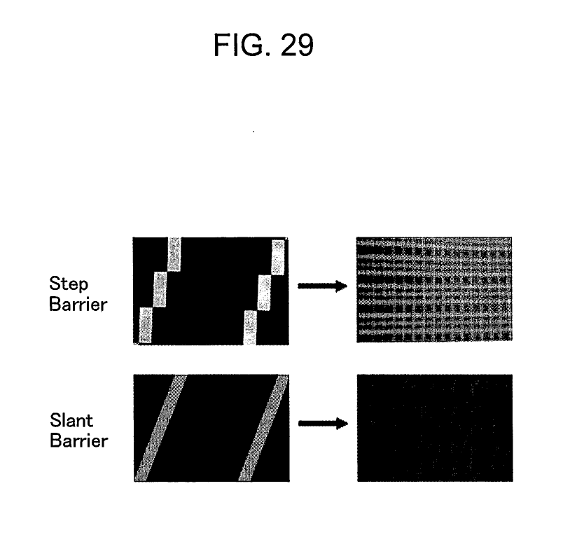

FIG. 30 is a schematic view showing a stereoscopic image display device/method using a conventional parallax barrier;

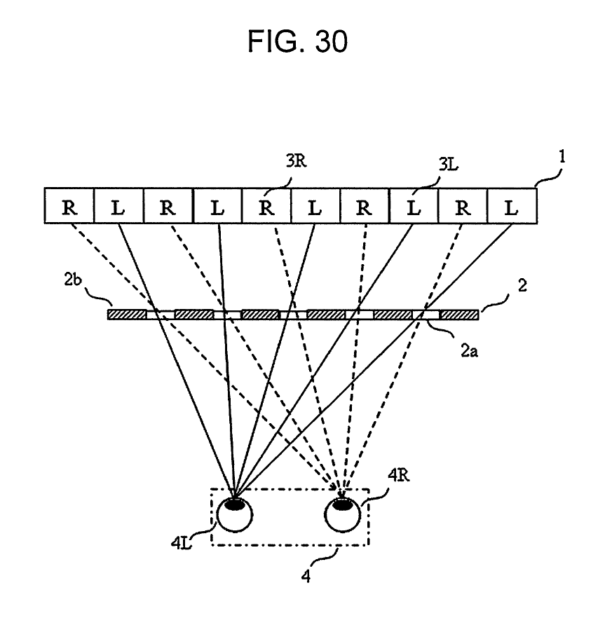

FIG. 31 is a schematic view showing a stereoscopic image display device/method using a parallax barrier according to a conventional example 2;

FIG. 32 is a schematic view showing a pixel arrangement example 3 where parallax images are alternately arranged in sub-pixel units per three image rows and a striped barrier aperture 9 having a corresponding inclination with an image display device according to the conventional example 2;

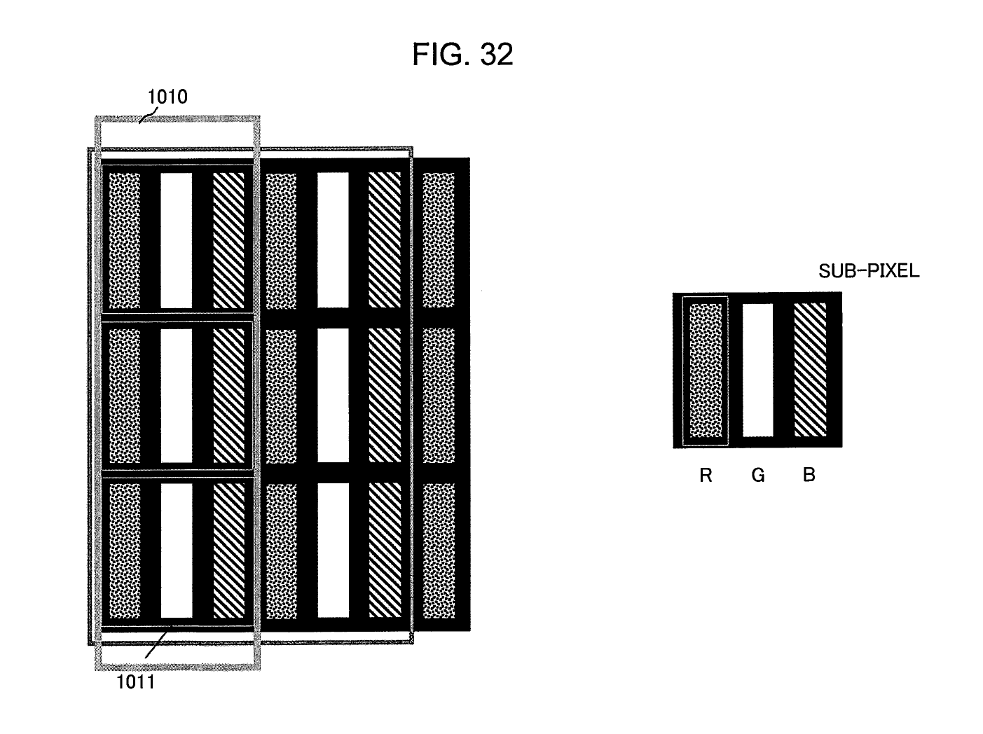

FIG. 33 is a schematic view showing how an adjacent pixel becomes observed through the barrier aperture 9 when the head is moved with respect to the image display device according to the conventional example 2;

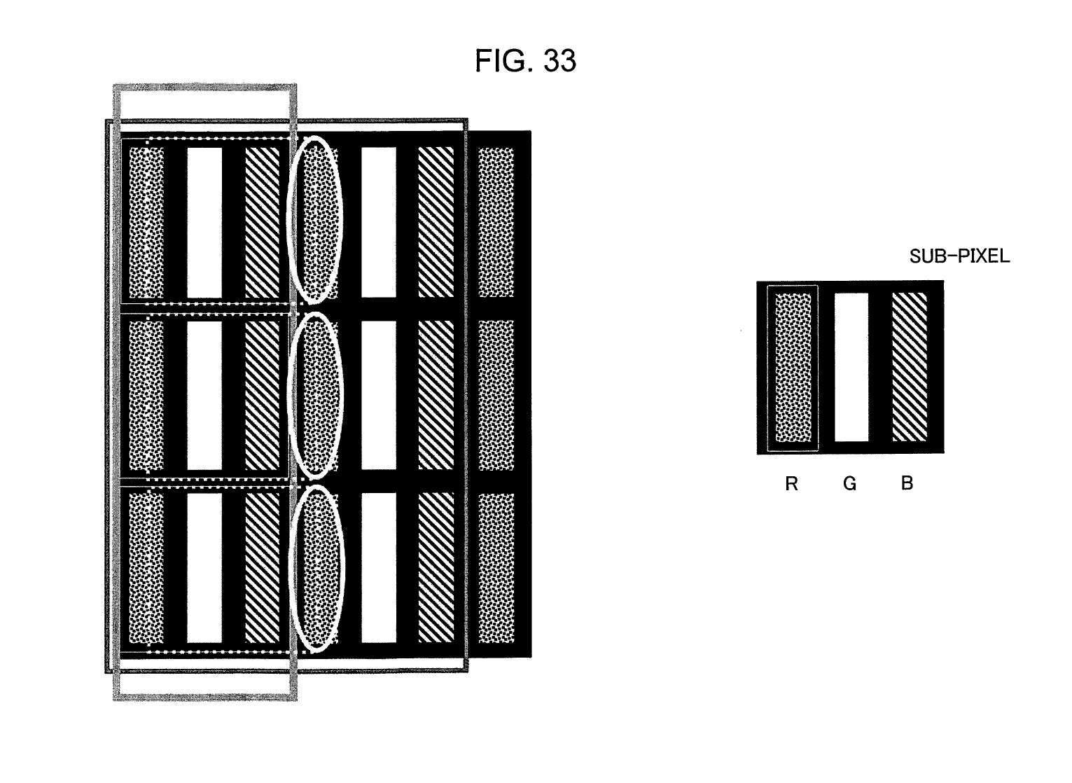

FIG. 34 shows a modification example 3 of the image display device as the second invention according to the present invention;

FIG. 35 shows a modification example of the image display device as the third invention according to the present invention;

FIG. 36 is a schematic view showing an application to a barrier pattern shape having a rectangular aperture, which is staggered in every other row by one sub-pixel in the image display device as the third invention according to the present invention;

FIG. 37 is a schematic view showing an application to a case where a lenticular lens is used in the image display device as the third invention according to the present invention;

FIG. 38 is a schematic view showing an application to a system where a parallax barrier as an image separating means is situated between a liquid crystal panel of a liquid crystal display and a backlight in the image display device as the third invention according to the present invention;

FIG. 39 is a schematic view showing an application to a case where a light source with a stripe light emitter is used in the image display device as the third invention according to the present invention;

FIG. 40 is a schematic view showing the pixel arrangement example 2 where parallax images of an image display device as the fifth invention according to the present invention are alternately arranged in sub-pixel units per two image rows, and a slant barrier aperture with an inclination of 4:1;

FIG. 41 is a schematic view showing the pixel arrangement example 2 where parallax images of the image display device as the fifth invention according to the present invention are alternately arranged in sub-pixel units per two image rows, and a slant barrier aperture with an inclination of 9:2;

FIG. 42 is a schematic view showing the pixel arrangement example 2 where parallax images of the image display device as the fifth invention according to the present invention are alternately arranged in sub-pixel units per two image rows, and a slant barrier aperture with an inclination of 15:3;

FIG. 43 is a schematic view showing the pixel arrangement example 2 where parallax images of the image display device as the fifth invention according to the present invention are alternately arranged in sub-pixel units per two image rows, and a slant barrier aperture with an inclination of 15:4;

FIG. 44 is a schematic view showing the pixel arrangement example 2 where parallax images of the image display device as the fifth invention according to the present invention are alternately arranged in sub-pixel units per two image rows, and a slant barrier aperture with an inclination of 21:5;

FIG. 45 is a schematic view showing the pixel arrangement example 2 where parallax images of the image display device as the fifth invention according to the present invention are alternately arranged in sub-pixel units per two image rows, and a slant barrier aperture 1 with an inclination of 21:4;

FIG. 46 is a schematic view showing the pixel arrangement example 2 where parallax images of the image display device as the fifth invention according to the present invention are alternately arranged in sub-pixel units per two image rows, and a slant barrier aperture with an inclination of 27:5;

FIG. 47 is a schematic view showing the pixel arrangement example 2 where parallax images of the image display device as the fifth invention according to the present invention are alternately arranged in sub-pixel units per two image rows, and a slant barrier aperture with an inclination of 27:6; and

FIG. 48 is a schematic view showing the pixel arrangement example 2 where parallax images of the image display device as the fifth invention according to the present invention are alternately arranged in sub-pixel units per two image rows, and a slant barrier aperture with an inclination of 27:7.

### DESCRIPTION OF THE PREFERRED EMBODIMENTS

Hereinafter, the first to fifth embodiments are described as preferred embodiments of the present invention.

In the first embodiment, a device, which has a slant barrier aperture with an inclination of 3:2 and alternately arranges parallax images in sub-pixel units per two image rows, and a device including a barrier pattern provided with a fine notched structure so that an aperture width periodically varies so as to be horizontally symmetrical are described.

In the second embodiment, a device, which has a slant barrier aperture with an inclination of 3:1 and alternately arranges parallax images in sub-pixel units per two image rows, and a device including a barrier pattern provided with a fine notched structure so that an aperture width periodically varies so as to be horizontally symmetrical are described.

In the third embodiment, a device configured to change an arrangement combination of alternately arranging image rows extracted from each parallax image in response to a viewer position obtained from a position detecting means which detects a position of the head or eyes of a viewer is described, in addition to the first or second invention.

In the fourth embodiment, a device configured to change an arrangement combination of alternately arranging image rows extracted from each parallax image in response to a viewer position obtained from a position detecting means, which detects a position of the head or eyes of a viewer, and form an aperture shape by controlling transmittance of a region in which light transmittance is variably controlled in response to an inclination angle formed by the image rows and a width of the image rows of each of the arranged parallax images are described, in addition to the first or second invention.

In the fifth embodiment, a device, which has a slant barrier aperture with an inclination of any one of 15:3 (an inclination of 11.3 degrees with respect to the vertical direction), 9:2 (an inclination of 12.52 degrees with respect to the vertical direction), 21:5 (an inclination of 13.39 degrees with respect to the vertical direction), 4:1 (an inclination of 14.04 degrees with respect to the vertical direction), 27:7 (an inclination of 14.53 degrees with respect to the vertical direction), and 15:4 (an inclination of 14.93 degrees with respect to the vertical direction) and alternately arranges parallax images in sub-pixel units per two image rows, and a device including a barrier pattern provided with a fine notched structure so that an aperture width periodically varies so as to be horizontally symmetrical are described.

### First Embodiment

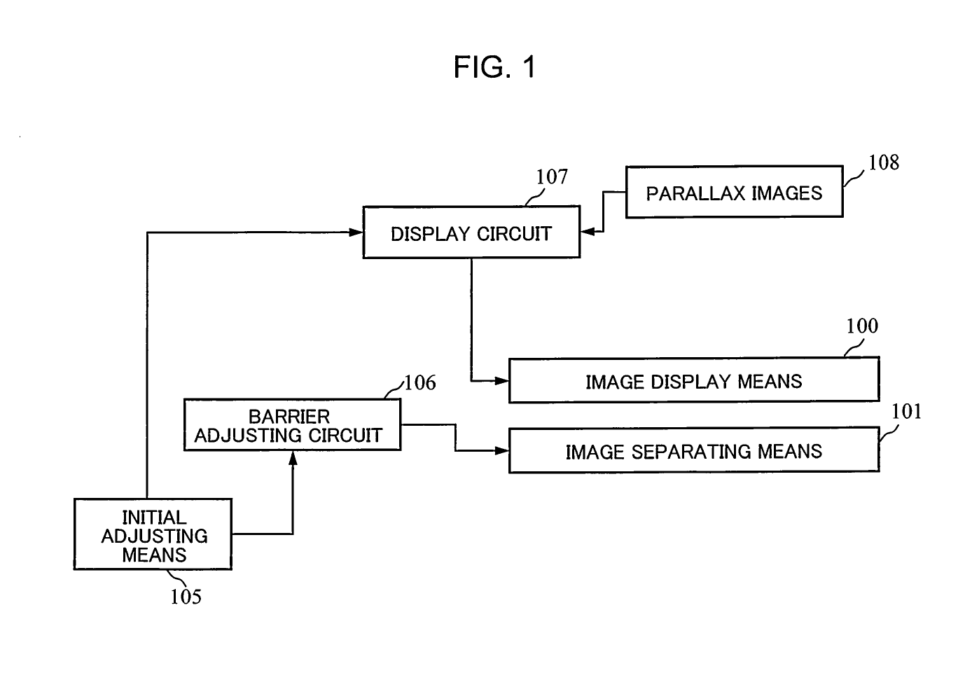

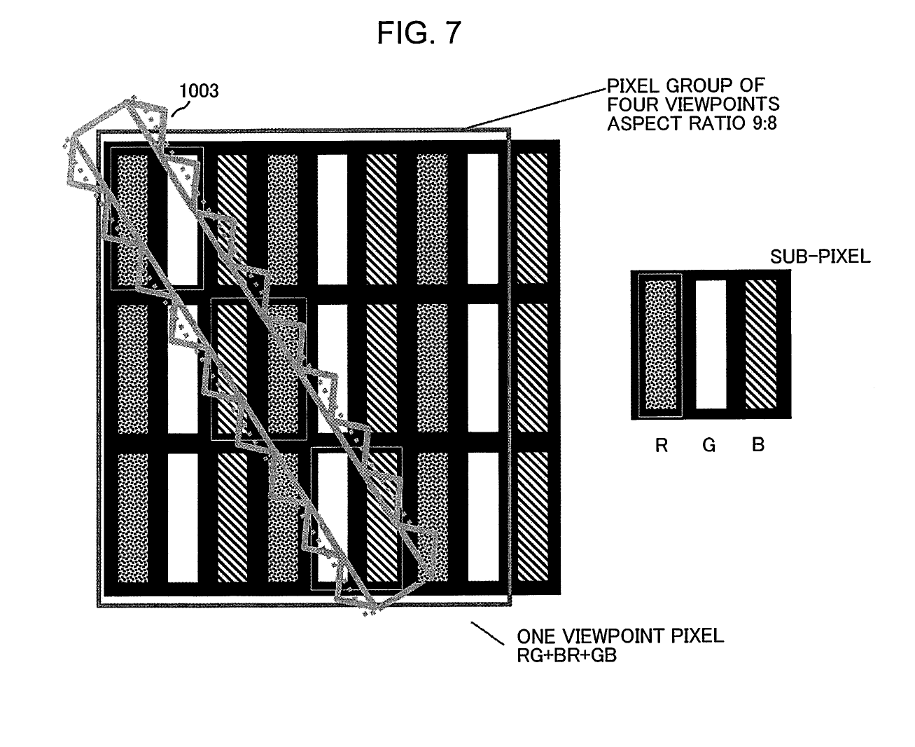

As the first embodiment of the present invention, a device which alternately arranges parallax images in sub-pixel units per two image rows and has a slant barrier aperture with an inclination of 3:2 is described with reference to FIGS. 1 to 9.

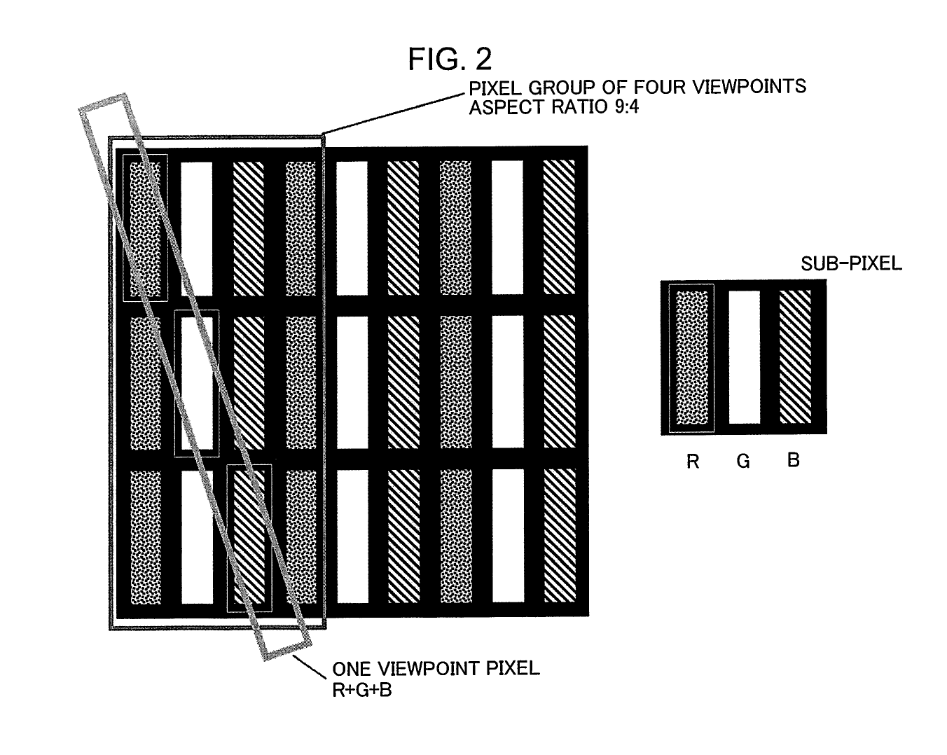

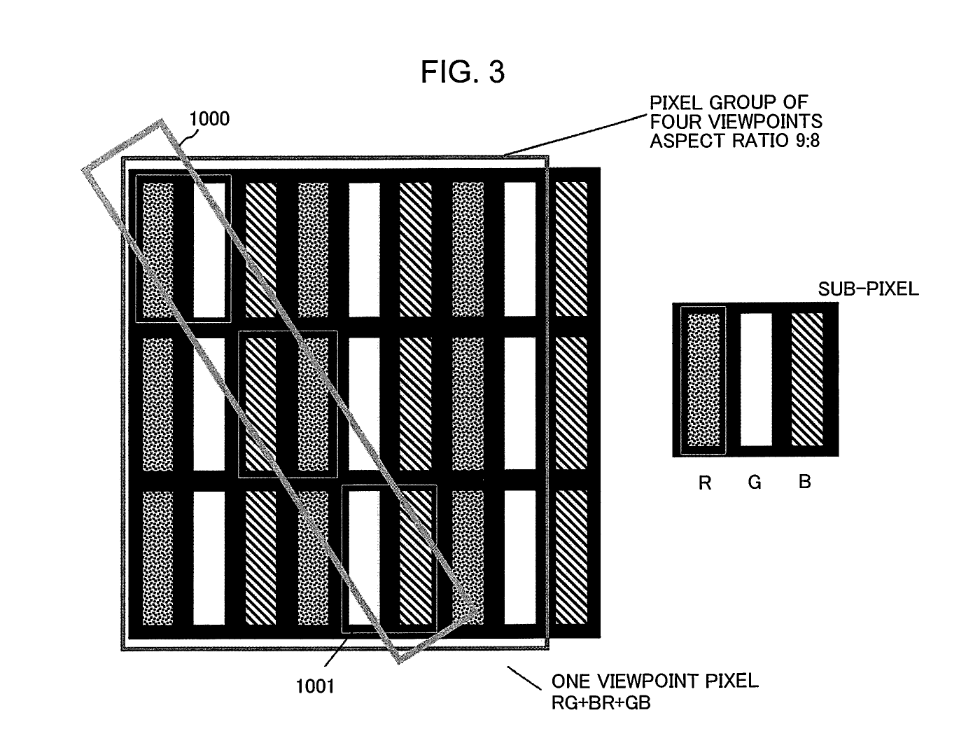

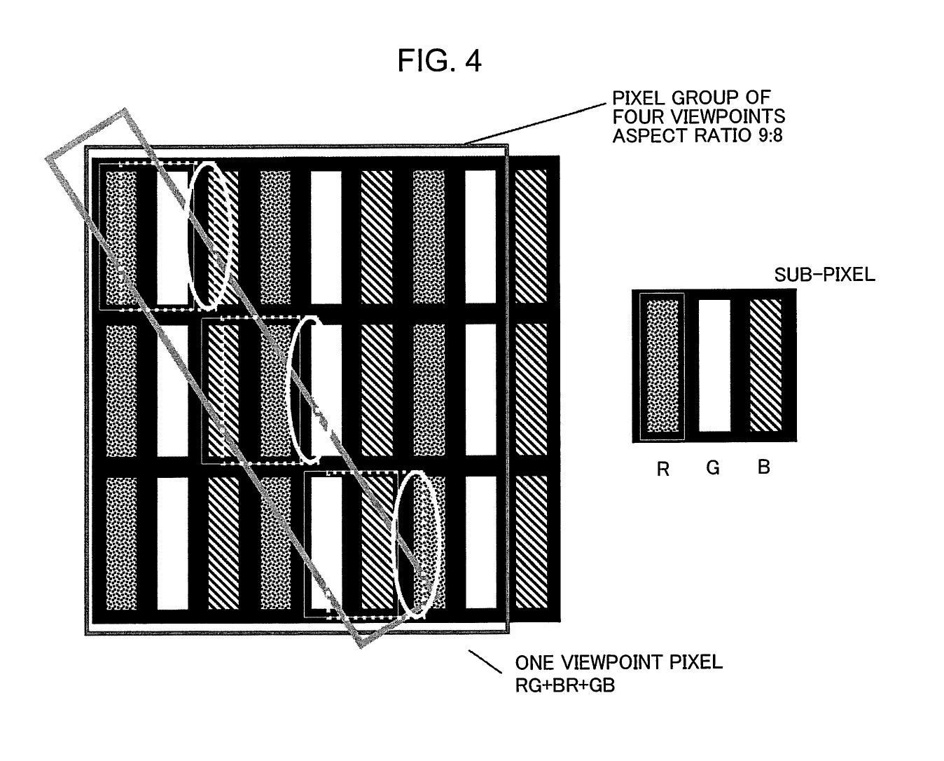

FIG. 1 shows a configuration of an image display device as the first embodiment of the present invention. FIG. 2 shows an image arrangement in which parallax images are alternately arranged per an image row and a slant barrier example 1 with an inclination of 3:1, which are used in conventional examples. FIG. 3 shows an image arrangement example 1, in which parallax images are alternately arranged in sub-pixel units per two image rows, and the slant barrier example 1 with an inclination of 3:2. FIG. 4 schematically shows how an adjacent pixel becomes observed through a slant barrier aperture when the head is moved in the first embodiment. FIGS. 2 to 4 show exemplary cases where parallax number n=4. In FIGS. 2 to 4, a screen on which a barrier pattern is created is viewed from a panel side. As shown in FIG. 1, the image display device includes an initial adjusting means 105, which adjusts a display device, a parallax barrier and alike, an image display means 100, which displays a two-dimensional parallax image, a display circuit 107 of the image display means 100, an image separating means 101 such as a parallax barrier for transmitting image light from the image display means 100 through an aperture or shielding image light from the image display means 100 to show a parallax image at a predetermined position, a barrier adjusting circuit 106, which adjusts a distance between the separating means and the image display means, a position of the separating means and alike, and parallax composite images 108 displayed on the image display means 100 through the display circuit. It should be noted that a fixed barrier made of a thin film or a substance with high transparency (such as glass) or a device (such as a TFT liquid crystal panel) capable of varying shielding and aperture (light transmittance) when a voltage or alike is applied may be used as the parallax barrier 101. At the beginning of image display or upon initial installation in a room such as a living room, the initial adjusting means 105 adjusts a display device, a parallax barrier and alike. With an active parallax barrier constituted by a TFT liquid crystal panel or alike, adjustment to a barrier pitch width or a barrier position at a predetermined proper viewing distance is performed (positional control to an aperture portion and a shielded portion is performed per pixel or sub-pixel basis). With regard to a fixed barrier, adjustment to a distance between the barrier and a display or an inclination of the barrier is performed by means of a predetermined adjustment image.

Meanwhile, stereoscopic image viewing evaluation using a test image from a proper viewing distance is performed. Tuning or alike of gradation characteristics is then performed using the display circuit on the basis of visibility and a degree of blur/fusion. It should be noted that parallax amount control (intensity control or adjustment to a horizontal shift amount using a linear coefficient) within a parallax image may be conducted although it depends on a situation. Parallax composite images 108 displayed by the image display means 100 are separated by the image separating means 101 so that a predetermined parallax image may be observed at a predetermined position. Therefore, a stereoscopic image may be observed at a position of an observer observing different parallax images with each of the left and right eyes. The image separating means 101 is constituted by an aperture portion and a shielding portion. As shown in the left view in FIG. 2, the aperture portion often has a slant barrier structure, which is arranged at a predetermined pitch and inclined in a diagonal direction, or a step barrier structure having a rectangular structure that conforms to a sub-pixel size. A barrier pitch by is geometrically determined on the basis of a sub-pixel pitch sp, a proper viewing distance L, a distance d between a panel and a barrier, and a parallax number nn. With respect to an interocular distance E, a proper viewing distance L1 of the conventional example shown in FIG. 2, where parallax images are alternately arranged in sub-pixel units per an image row, and a proper viewing distance L2 according to the first embodiment shown in FIG. 3 where parallax images are alternately arranged in sub-pixel units per two image rows may be expressed by (Expression 1).

[Expression 1]

L1=E×d/sp

L2=E×d/(sp×2) (1)

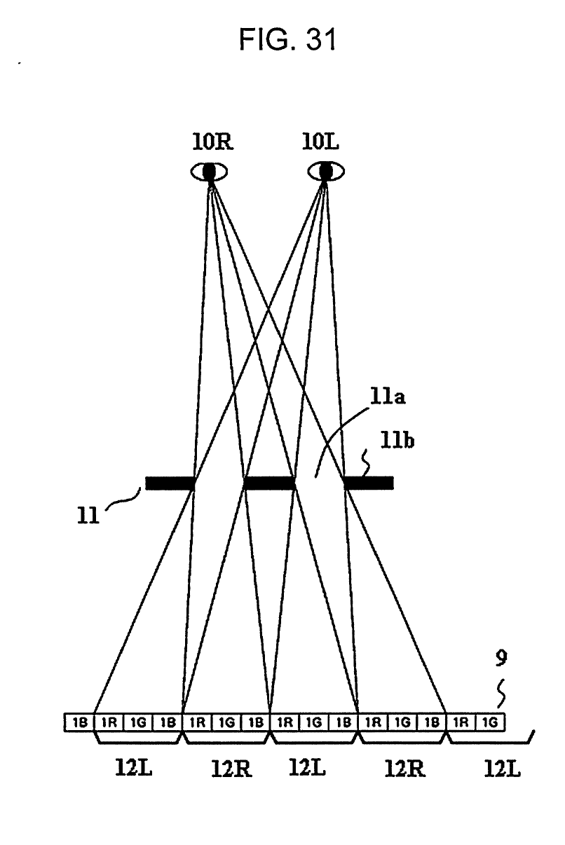

L2=L1×0.5 is derived from (Expression 1), which means that the proper viewing distance may be shortened to ½ under a consistent distance d between the panel and the barrier. A size of the aperture (a width of the aperture when considering parallax in the horizontal direction) may be adjusted in order to reduce moiré patterns and crosstalk/blur that is created when adjacent parallax images coexist. However, there is a tradeoff between moiré intensity and an crosstalk amount. Therefore, improving one is likely to worsen the other. In other words, although an aperture width bh is often set to k-times (k>1) as great as a sub-pixel sp in order to reduce moiré with a slant barrier as shown in FIG. 2, this increases a crosstalk amount as an adverse effect which makes a pixel included in an adjacent parallax image visible. In contrast, with an example in which parallax images are alternately arranged in sub-pixel units per two image rows as shown in FIG. 3, even when the aperture width bh is set to bh=2×sp in order to make two image rows visible, an aperture width may be increased so that moiré is more likely to be reduced than conventional arts. On the other hand, when bh=2×sp, since a proportion of pixels included in an adjacent parallax image is comparable to a case where the aperture width is equal to the sub-pixel size sp according to the conventional example 1, the crosstalk amount does not increase. Since one viewpoint pixel is constituted by RG+BR+GB, color balance does not deteriorate. Even when the observer moves slightly to the left or right, since B+G+R of an adjacent viewpoint pixel becomes simultaneously visible as shown in FIG. 4 (white circles in FIG. 4), color moiré is less likely to occur than in the case of the conventional example 2 (FIG. 31).

It should be noted that when the aperture width bh is set smaller than two sub-pixels such as bh=sp×1.5, a proportion of a visible adjacent viewpoint becomes smaller than the case where the aperture width is equal to the sub-pixel size sp according to the conventional example 1 so that the crosstalk amount decreases. Since the aperture width bh is set to bh=sp×1.5, moiré is reduced in comparison to the case where the aperture width is equal to the sub-pixel size sp according to the conventional example 1.

A ratio between a pixel size in the horizontal direction and a pixel size in the vertical direction (aspect ratio) in a group unit that constitutes every one pixel with a parallax number nn is 9:nn in the case of the alternate arrangement in sub-pixel units per an image row shown in FIG. 2 whereas the ratio is 9:(2×nn) in the case of the alternate arrangement of plural parallax images in sub-pixel units per two image rows according to the first embodiment shown in FIG. 3. In a case where nn=4, the aspect ratio is 9:4 in FIG. 2 whereas the aspect ratio is 9:8 in the example shown in FIG. 3. Consequently, since a balance between horizontal and vertical pixel arrangements improves, there is an advantage that “the jagged feel or unevenness” of contours and alike appear to be reduced.

### Modification Example 1

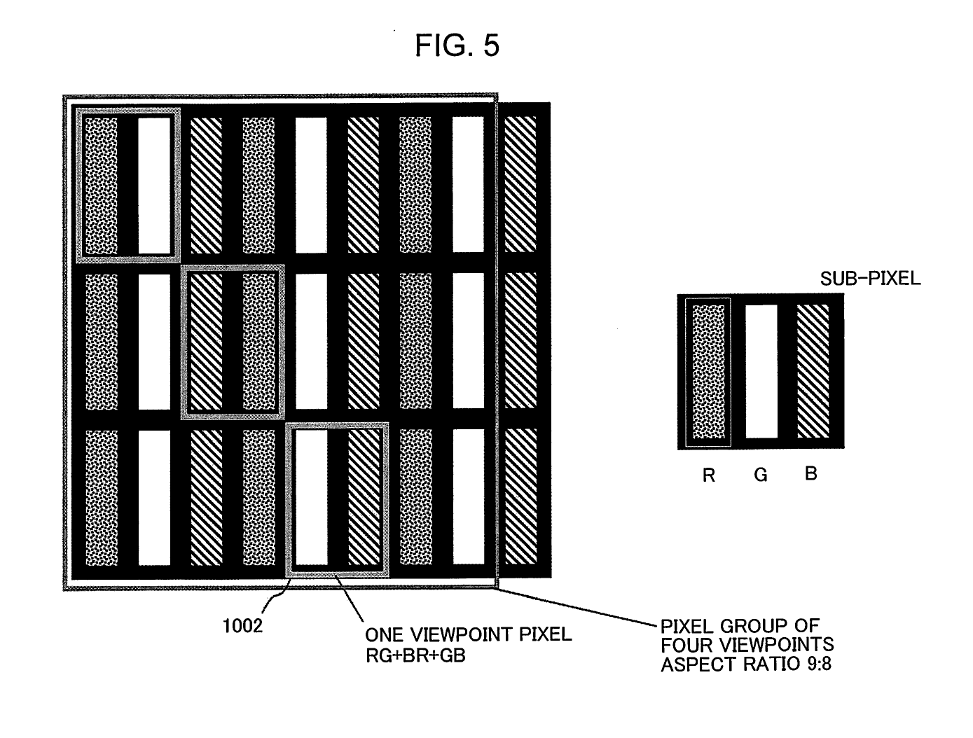

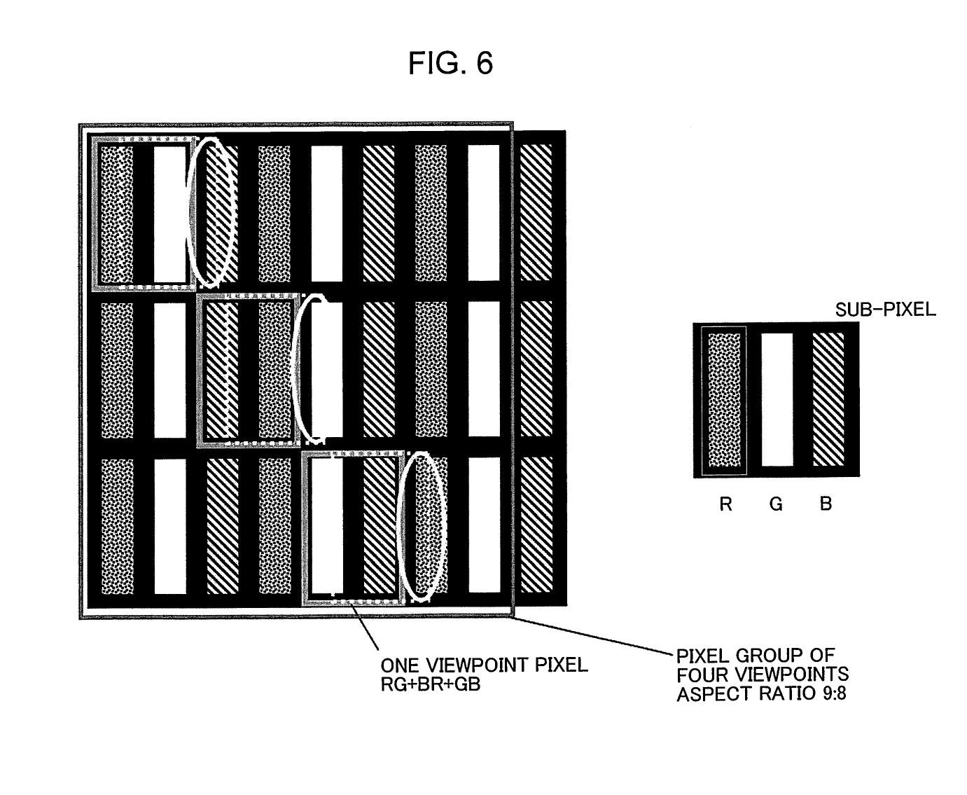

As a modification example 1 of the aforementioned first embodiment, a device which alternately arranges parallax images in sub-pixel units per two image rows (pixel arrangement example 1) and has a step barrier aperture 2 with an inclination of 3:2 (in a case of four parallaxes) is described with reference to FIGS. 1, 5 and 6. The device is configured as shown in FIG. 1. Pixels are arranged as shown in FIG. 5. Parallax images are alternately arranged in sub-pixel units per two image rows. A step barrier is a structure in which apertures with a horizontal aperture width bh as great as sub-pixel sp×2 and a vertical aperture width bh as great as pixel width sp×3 are arranged in a staircase pattern. In this case, inclination is 3:2. Like the first embodiment, the proper viewing distance is shortened to ½ when the distance d between the panel and the barrier remains the same as that in the conventional example 1. As apparent from FIG. 6, the descriptions “since one viewpoint pixel is constituted by RG+BR+GB, color balance does not deteriorate” and “even when the observer moves slightly to the left or right, B+G+R of an adjacent pixel becomes simultaneously visible (white circles)” hold true. Since the aperture width is equal to two sub-pixels, moiré is conceivably reduced. In the case of four parallaxes, since the horizontal and vertical proportions approach each other in pixel group units of one parallax, there is an advantage that “the jagged feel or unevenness of contours” is reduced. It should be noted that crosstalk is less likely to vary from a conventional step barrier which is alternately arranged in one sub-pixel units and has an inclination of 3:1, even in this case.

### Modification Example 2

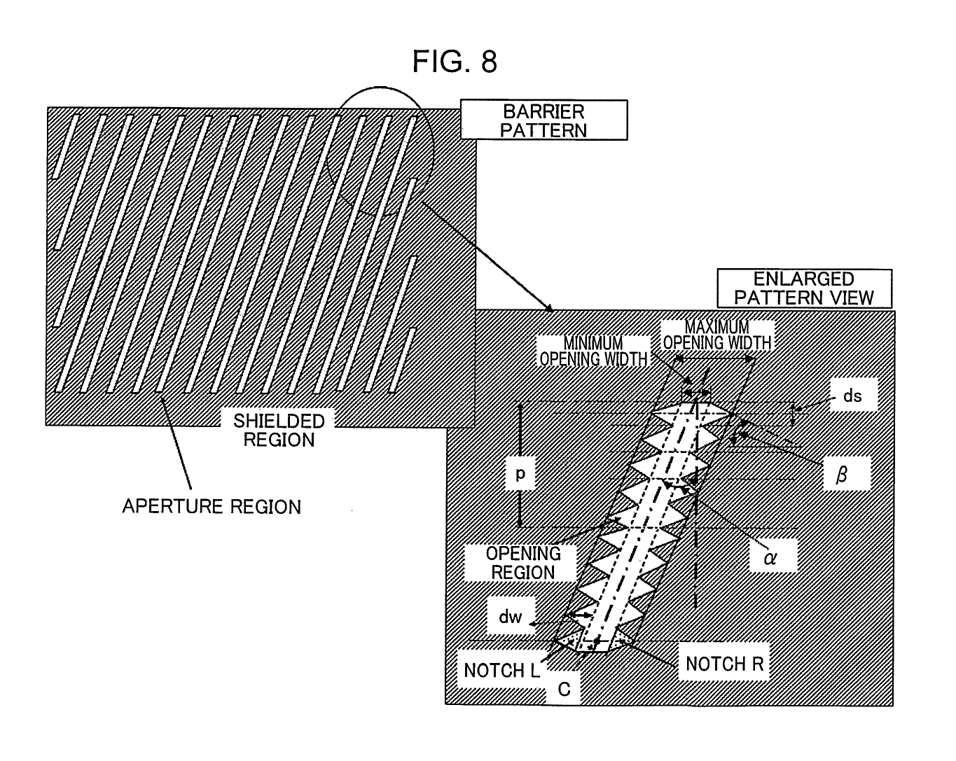

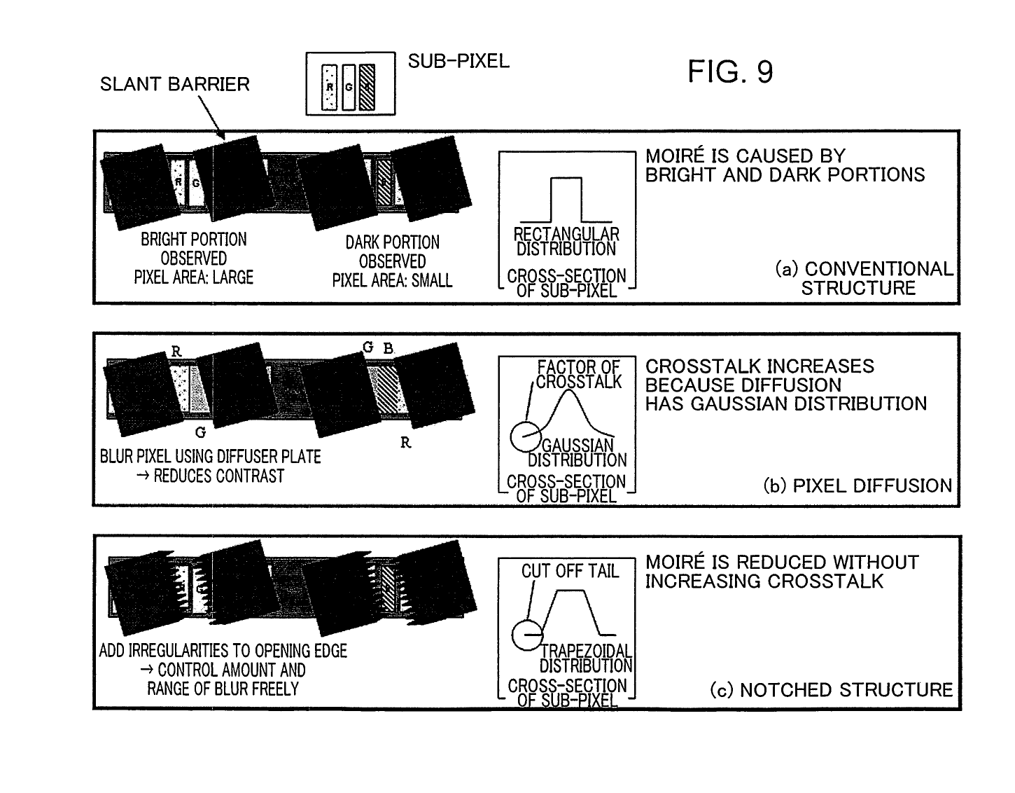

As a modification example 2 of the aforementioned first embodiment, a device of which a barrier pattern with an inclination of 3:2 is provided with a fine notched structure so that an aperture width periodically varies so as to be horizontally symmetrical by adding irregularities to an aperture edge in order to enable an amount/range of blur of pixels observed through a barrier to be controlled is described with reference to FIGS. 1 and 7 to 9. The modification example 2 is configured so as to reduce moiré contrast without increasing crosstalk by constructing a shape of the barrier aperture 3 by adding an uneven structure (herein, defined as a notched structure), which is determined by a predetermined fineness, to a slant barrier structure as shown in FIG. 8. FIG. 8 shows an example in which a triangular structure is added to an aperture of a slant barrier having a minimum aperture width so that an aperture width periodically and linearly varies between a maximum aperture width hmax and a minimum aperture width hmin. Left and right triangles are symmetrical with respect to the point C on the central axis of the barrier (c.f. notches R and L). As shown in FIG. 8, this pattern is defined by four parameters, namely, an inclination angle α of the central axis of the barrier with respect to the vertical direction, an inclination angle β of the notched structure (triangular) portion with respect to a horizontal axis, a period (height) ds of the notched structure, and a width dw of the notched structure. ds may be expressed using a number of repetitions n of the notched structure in one pixel width p as ds=p/n. In this case, normally, when each pixel is constituted by three sub-pixels R, G and B, p may be expressed using a sub-pixel size sp as p=3×sp. FIG. 9 shows an outline of an effect created by this uneven structure. Based on these drawings, a modification example of the image display device as the first embodiment of the present invention is described. For example, the width dw of the notched structure may be expressed as (Expression 2).

[Expression 2]

dw=0.5×ds×(1/tan β+tan α) (2)

It should be noted that although FIG. 9 is described with reference to a slant barrier structure, a similar effect is conceivably created with a conventional vertical striped barrier structure. With a barrier having a conventional striped structure, as shown in FIG. 9(a), a portion is bright (bright portion) when a pixel area observed through an aperture is large whereas another portion becomes darker (dark portion) when the pixel area observed through the aperture becomes smaller. Usually, since pixels are assembled in a predetermined parallax direction of an entire image at a predetermined proper viewing distance, a barrier pitch is set to a slightly smaller value than a product of a sub-pixel size multiplied by a parallax number nn. Consequently, a variation occurs in a relationship between the barrier and visible pixel positions when viewed from a given observing position. Therefore, as shown in FIG. 9(a), a bright-dark pattern is created and observed as moiré. In this case, the contrast of bright-dark pattern is conceivably perceived as moiré intensity. In contrast, as shown in FIG. 9(b), by blurring the contrast of light using a diffuser plate or a diffusing film which diffuses light to make a black matrix portion (in the case of a PDP, also referred to as a rib portion) or an auxiliary electrode less influential and reduce an amplitude of the contrast, moiré may become less noticeable. However, since diffusion characteristics often include a variation similar to a Gaussian distribution in the horizontal direction with respect to the center of an aperture, a blur or crosstalk of a parallax image is created near a contour, which is unfavorable in terms of image quality. On the other hand, when a notched structure is provided as shown in FIG. 9(c), for example, an amount or range of blur may be controlled by adding an uneven structure to an aperture edge so as to increase a pixel region to be hidden by the notched structure in a bright portion and increase a visible pixel region through the notched structure in a dark portion. In other words, as shown in the sectional view of a sub-pixel of FIG. 9(c), a rectangular distribution shown in the sectional view of a sub-pixel of FIG. 9(a) may be adjusted so as to assume a trapezoidal distribution by cutting off both end portions of the rectangular distribution.

In this case, due to the aforementioned characteristics, it is conceivable that this effect is greater when a width of the notched structure is somewhat narrow (a period of the notched structure is favorably somewhat large). However, an appropriate value of the width (i.e. the period) of the notched structure is dependent on pixel structure (in particular, metal auxiliary electrodes or alike which divide pixels in the vertical direction). For example, when one pixel is divided by m in the vertical direction, an effect of moiré reduction is enhanced when the number of repetitions n of the notched structure is in the vicinity of a product of m multiplied by an integer k, namely, n=k×m. On the other hand, when considering an influence of manufacturing errors, a value and that is a quotient of a sub-pixel size p in the vertical direction divided by the notch period ds is favorably a value that is apart from a vicinity of an integer. If possible, a notch period that is close to an intermediate value of consecutive integer ratios nn1 and nn1+1 or nn1−1 and nn1 is more favorable since the influence of manufacturing errors may be almost totally eliminated.

It should be noted that in the case of this notched structure, since the aperture width varies, a ratio (aperture ratio) rH of the aperture width to the sub-pixel size which is used as criteria of crosstalk also varies. However, in this case, the ratio is defined by an average aperture ratio Ave_rH within a predetermined range (e.g. a size of u-number of pixels). Therefore, it is assumed that a fine notched structure has crosstalk characteristics that are approximately equal to those of a diagonal slant barrier with the average aperture ratio and an inclination angle α of a central axis of a barrier. Accordingly, by setting the average aperture ratio to a predetermined value ThAve_rH and controlling an amount of blur by means of a notched structure constituted by irregularities, averaging of a visible pixel area may be performed with minimizing increase of the crosstalk amount. By adding such uneven portions to the aperture edge, moiré may be more suppressed than the first embodiment. By setting the average aperture ratio rH to lower than 2 (with respect to the sub-pixel size sp), crosstalk may be further suppressed.

Although the notched structure constituted by triangles is used in FIG. 9, the notched structure may alternatively be constituted by trapezoids, elliptical arcs with varying curvature or parallelograms. Although the present embodiment is described on the basis of a slant barrier structure, the present embodiment may be applied to a vertical striped barrier. Instead of providing a notched structure in the horizontal direction as shown in FIG. 2, a notched structure may be added in a direction perpendicular to the central axis of the barrier. Although a slant barrier is described as an example, the present embodiment may be applied to a vertical striped barrier or a step barrier in which rectangular shapes of sub-pixels are arranged in a diagonal direction.

It should be noted that if dw denotes a width of a notched structure and p denotes a size of one pixel, an aperture area dSn of the notched structure in one pixel and an aperture area dSo of a diagonal slant barrier having a minimum aperture width hmin in one pixel may be expressed as follows.

[Expression 3]

dSn=dw×p

dSo=hmin×p (3)

This expression shows that even if a number of divisions in one pixel increases, the aperture area S=dSo+dSn remains the same.

With keeping the pixel-size average aperture ratio Ave_rh at ThAve_rH, crosstalk reduction may be achieved by suppressing the maximum aperture width hmax so as to stay within a predetermined size LWMax=sp×dmax for the sub-pixel size sp=p/3. In this case, since a minimum aperture width of around sub-pixel size×0.5 or smaller is susceptible to adverse effects due to an abrupt fluctuation of the aperture width and an influence of a fluctuation in viewing position (horizontal/vertical), the minimum aperture width is favorably around sub-pixel size×0.7 or greater. Adding such a portion enables control of not only the average aperture ratio but also the maximum aperture width with respect to a sub-pixel sp that is a reference for parallax image arrangement. Consequently, a barrier pattern may be designed to be capable of suppressing moiré patterns with achieving greater crosstalk reduction.

### Second Embodiment

The second embodiment of the present invention is described with reference to FIGS. 1 and 10 to 17. As the second embodiment, a pixel arrangement example 2, in which parallax images are alternately arranged in sub-pixel units per two image rows, and stereoscopic image display by means of a slant barrier aperture 4 with an inclination of 3:1 are described.

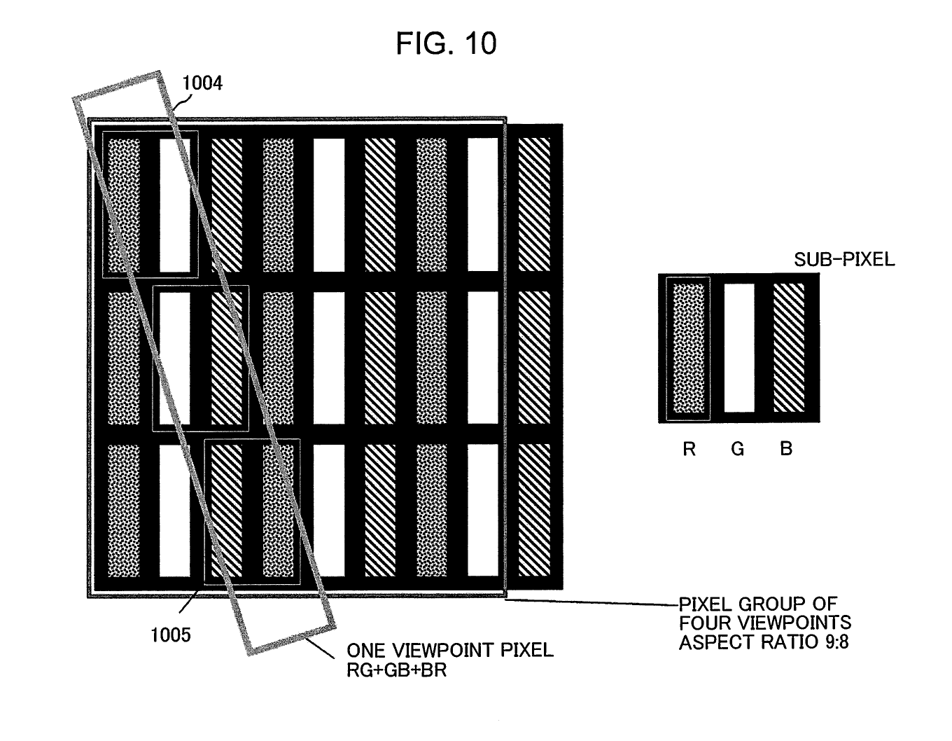

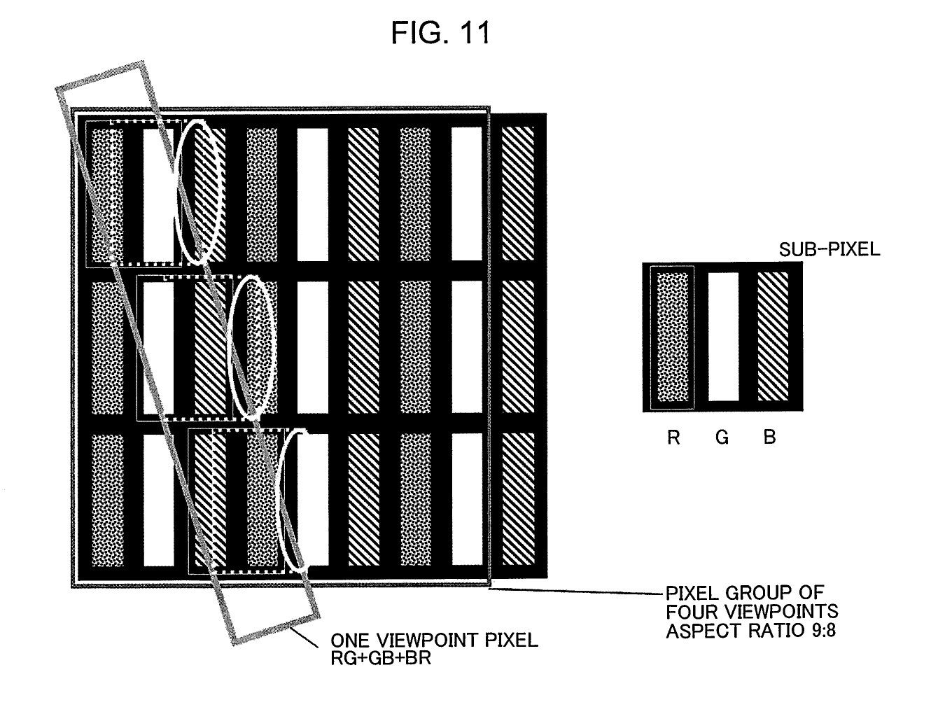

The present invention is configured as shown in FIG. 1. The operations are similar to those of the first embodiment. FIG. 10 schematically shows the pixel arrangement example 2 in the second embodiment, in which parallax images are alternately arranged in sub-pixel units per two image rows, and a slant barrier aperture 4 with an inclination of 3:1. FIG. 11 is a schematic view showing how an adjacent pixel becomes observed through the slant barrier aperture 4 when the head is moved with respect to the image display device. An inclination angle of the slant barrier with respect to the vertical direction is 18.435 degrees (3:1), which is significantly different from the inclination angle of 33.69 degrees (3:2) in the first embodiment. Normally, with a slant barrier structure, moiré tends to be reduced or eliminated between 20 and 30 degrees. However, since the aspect ratio of a pixel size is 3:1, there is a tendency that as the angle becomes steeper than 3:1, an area, in which the adjacent pixel is visible, widens to increase crosstalk. Like the present embodiment, considering the fact that moiré is reduced by alternately arranging parallax images in sub-pixel units per two image rows and setting the aperture width to a vicinity of sub-pixel×2, the inclination angle of the barrier is more favorably set to 3:1. The present embodiment represents this. Since B+G+R of an adjacent viewpoint pixel becomes simultaneously visible as shown in FIG. 11 when an observer moves slightly to the left or right, unlike the case of the conventional example 2 (FIG. 31), color moiré is less likely to occur and color balance at one viewpoint pixel is less likely to deteriorate. An aspect ratio of a group unit that realizes one pixel of the parallax number nn is 9:nn in the case shown in FIG. 10 where parallax images are alternately arranged in sub-pixel units per an image row. However, the aspect ratio of a group unit that realizes one pixel of the parallax number nn is 9:(2×nn) in the case shown in FIG. 10 where parallax images are alternately arranged in sub-pixel units per two image rows according to the first embodiment. If nn=4, an advantage of improving a balance of horizontal and vertical pixel arrangements may be obtained like the first embodiment.

### Modification Example 1

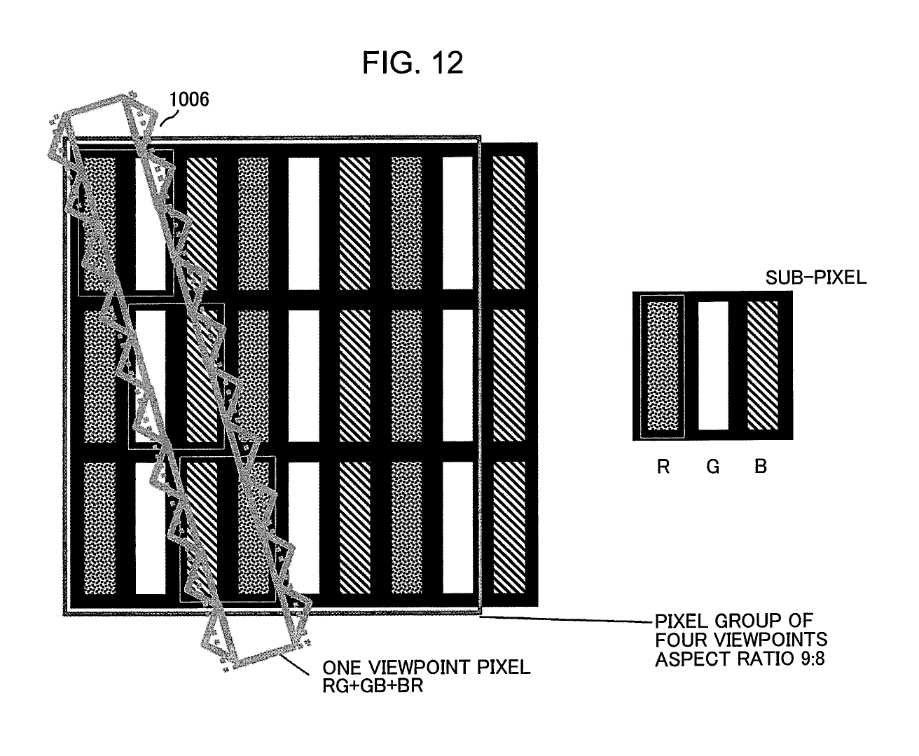

As a modification example 1, the example 5 is described with reference to FIG. 12 in which a barrier pattern is provided with a fine notched structure so that an aperture width periodically varies so as to be horizontally symmetrical and irregularities are added to an aperture edge so that an amount/range of blur of pixels observed through a barrier may be controlled. Like the modification example 2 of the first embodiment, the modification example 1 of the second embodiment facilitates moiré reduction by adding the uneven structure (notched structure) described with reference to FIGS. 8 and 9 to an aperture edge. By adopting this method, a reduction in crosstalk may be simultaneously achieved since moiré may be reduced with setting the average aperture ratio Ave_rh to a smaller value (e.g. sp×1.2 to sp×1.6) than sub-pixel sp×2. With keeping the pixel-size average aperture ratio Ave_rh at ThAve_rH, further crosstalk reduction may be achieved by suppressing the maximum aperture width hmax so as to stay within a predetermined size LWMax=sp×dmax for the sub-pixel size sp=p/3. In this case, since a minimum aperture width of around sub-pixel size×0.5 or smaller is susceptible to adverse effects due to an abrupt fluctuation of the aperture width and an influence of a fluctuation in viewing position (horizontal/vertical), the minimum aperture width is favorably around sub-pixel size×0.7 or greater. Adding such a portion enables control of not only the average aperture ratio but also the maximum aperture width with respect to a sub-pixel sp that is a reference for parallax image arrangement. Consequently, a barrier pattern may be designed to be capable of suppressing moiré patterns with achieving greater crosstalk reduction.

### Modification Example 2

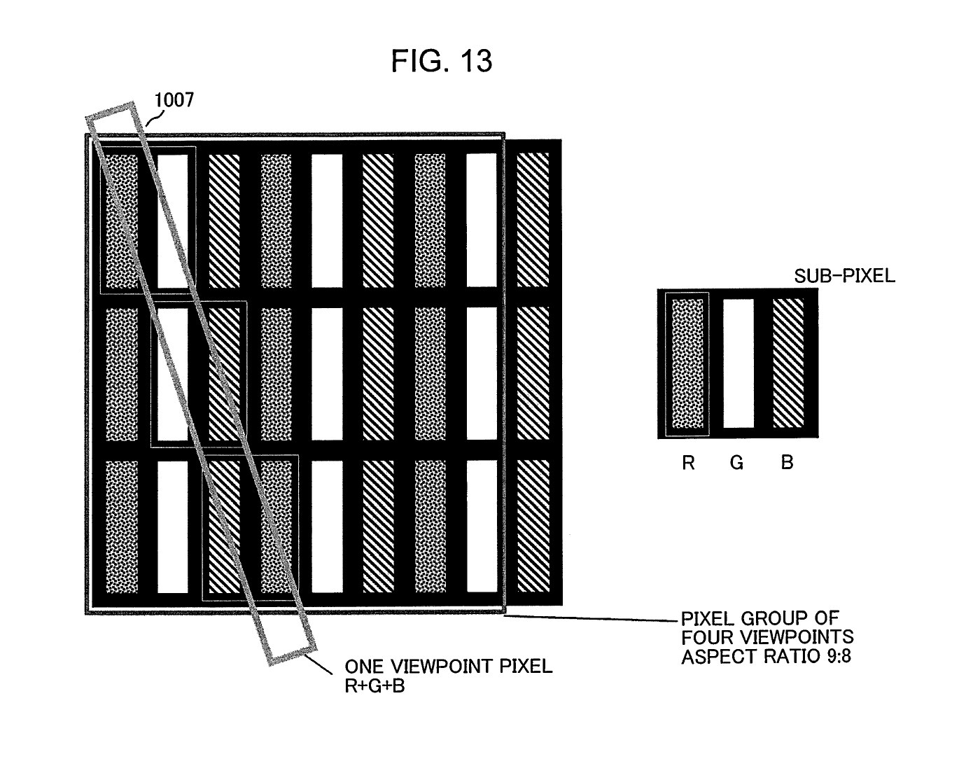

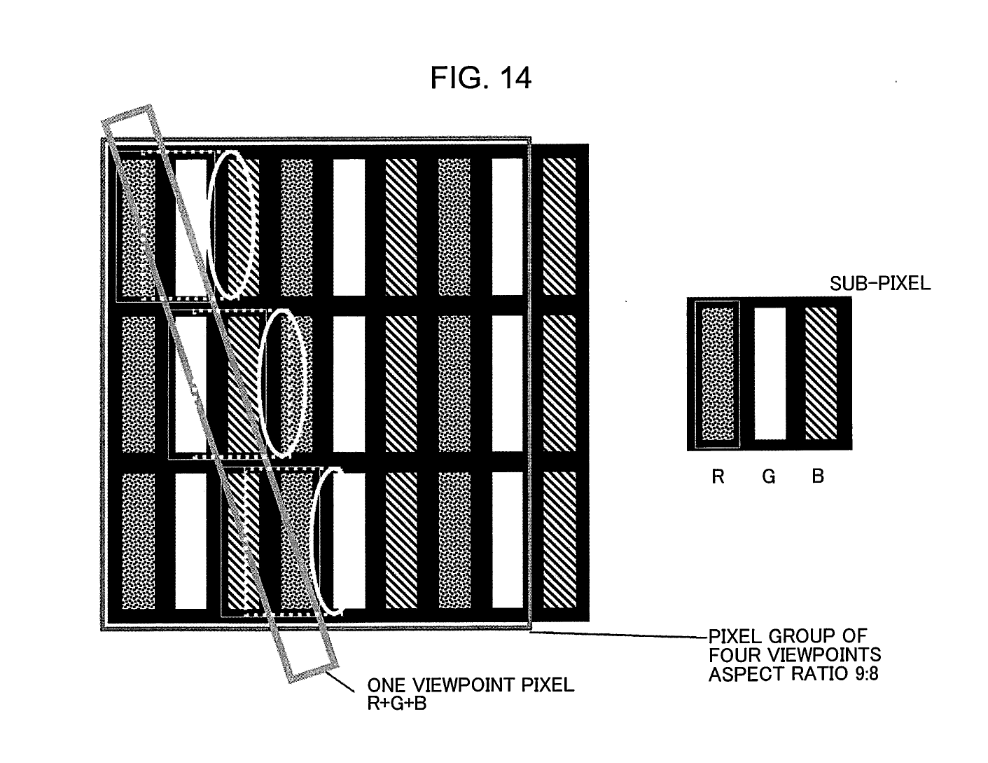

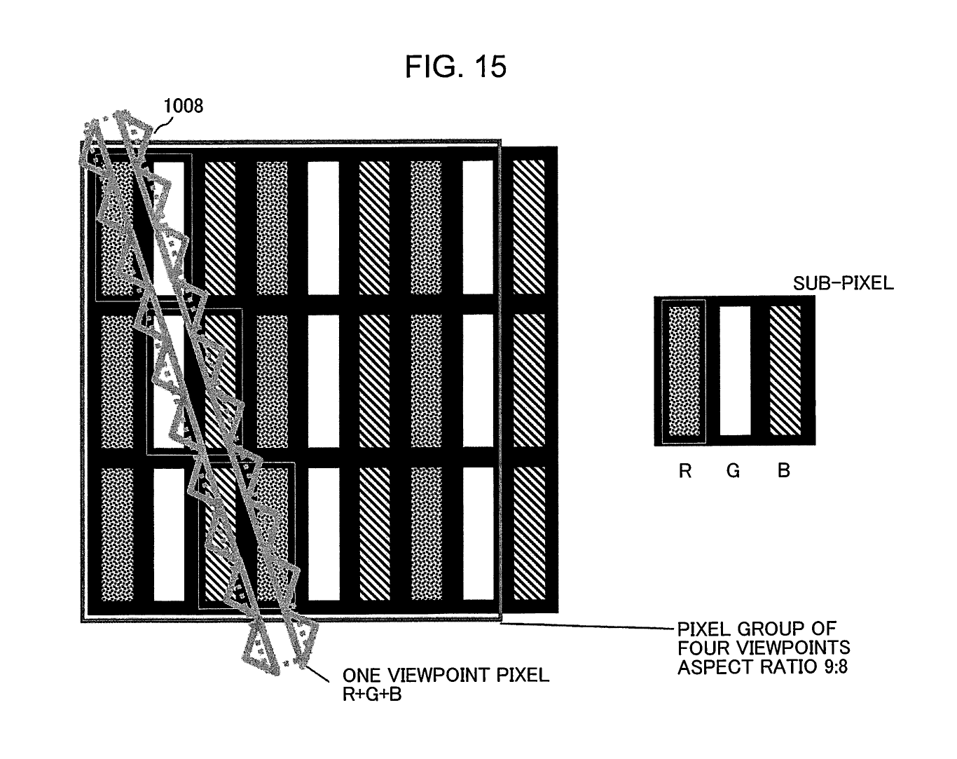

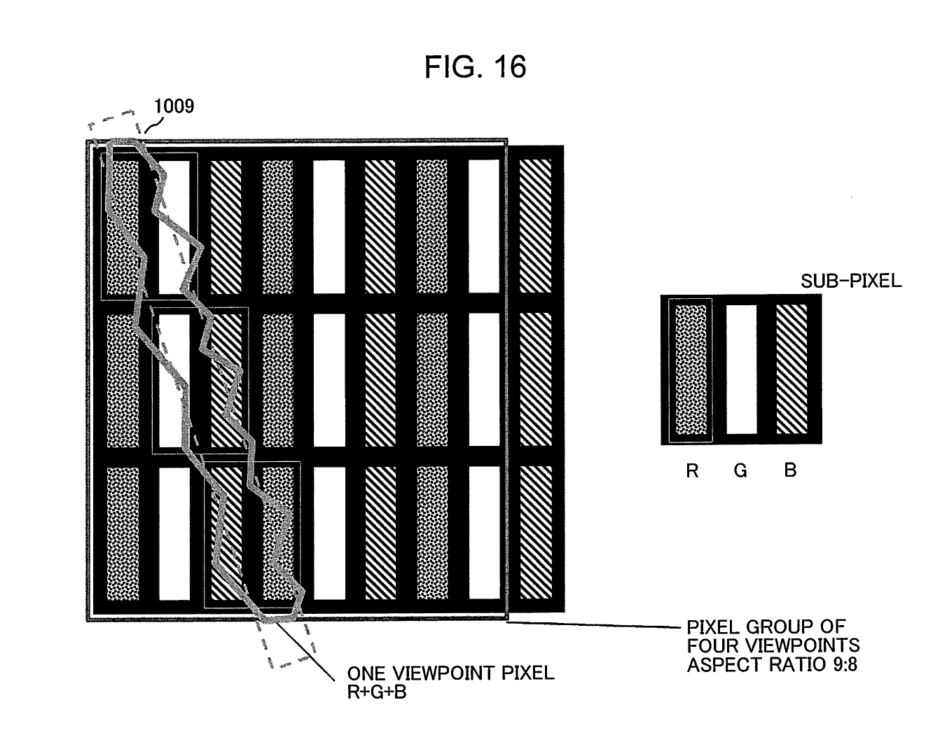

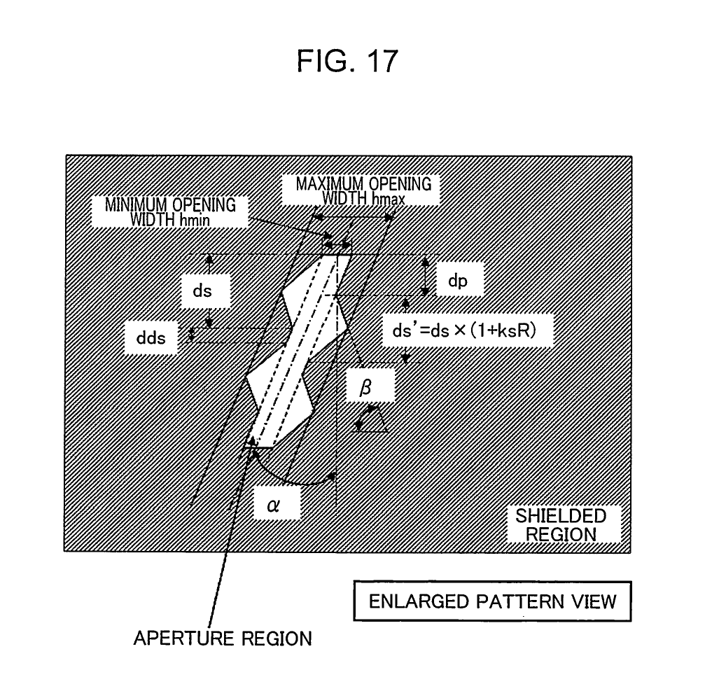

The modification example 2 of the second embodiment in which the aperture width is reduced from the sub-pixel sp to a smaller value than sub-pixel sp×2 is described. FIG. 13 schematically shows the barrier shape example 6. In this manner, by setting the barrier aperture width according to the present second embodiment smaller than sub-pixel sp×2 (e.g. around sp×1 to sp×1.4), an advantage of significantly reducing crosstalk may be obtained since a row of viewpoint images adjacent to an object row of viewpoint images may be substantially prevented from leaking and becoming observed through the barrier. As shown in FIG. 14, since B+G+R of an adjacent viewpoint pixel becomes simultaneously visible when the observer moves slightly to the left or right, color moiré is less likely to occur and color balance at one viewpoint pixel is less likely to deteriorate, unlike the case of the conventional example 2 (FIG. 31). However, since the aperture width is smaller, moiré reduction may be insufficient. Conceivable methods for solving this issue include systems shown in FIGS. 15, 16 and 17. FIG. 15 shows a barrier shape example 7 according to the modification example 2 in which a barrier pattern is provided with a fine notched structure so that an aperture width periodically varies so as to be horizontally symmetrical and irregularities are added to an aperture edge so that an amount/range of blur of pixels observed through a barrier may be controlled. As an alternative invention of the modification example 3, FIG. 16 shows a barrier shape example 8 which uses FIG. 17 having a wider adjustment range as a notched structure by adding variation parameters for a phase shift between left and right notched structures, a gap between notched structures and a maximum aperture width. By adopting the configuration shown in FIG. 15, the barrier pattern according to the modification example 2 may acquire the moiré reduction effect as described about the modifications of the first embodiment. With keeping the pixel-size average aperture ratio Ave_rh at ThAve_rH, crosstalk reduction may be further facilitated by suppressing the maximum aperture width hmax so as to stay within a predetermined size LWMax=sp×dmax for the sub-pixel size sp=p/3. In this case, since a minimum aperture width of around sub-pixel size×0.5 or smaller is susceptible to adverse effects due to an abrupt fluctuation of the aperture width and an influence of a fluctuation in viewing position (horizontal/vertical), the minimum aperture width is favorably around sub-pixel size×0.7 or greater. Adding such a portion enables control of not only the average aperture ratio but also the maximum aperture width with respect to a sub-pixel sp that is a reference for parallax image arrangement. Consequently, a barrier pattern may be designed to be capable of suppressing moiré patterns with achieving greater crosstalk reduction.

By using an asymmetrical notched structure as shown in FIG. 17, a barrier pattern with a comparable moiré level but more superior in terms of crosstalk may be designed. This represents addition of a phase shift dp between left and right notched structures, a gap dds between the notched structures, and a variation parameter kdsR of a height of the right notched structure. In this case, by adding an uneven structure to an edge of an aperture so that, for example, a pixel region, which is hidden by the notched structure in a bright portion, is increased whereas a visible pixel region through the notched structure in a dark portion is increased, like FIG. 9(c), an amount or range of blur may be advantageously controlled over a wider adjustment range. Consequently, barrier parameter evaluation or adjustment to various parameters may be performed by taking manufacturing errors during manufacturing a barrier pattern into consideration as tolerance in advance. Evaluation of barrier parameters by taking manufacturing errors into consideration may be performed by considering predetermined manufacturing errors err (%) for a location where errors are likely to occur such as the minimum aperture width hmin and estimating a moiré pattern by adding the manufacturing errors err (%) when estimating and evaluating moiré.

It should be noted that although a notched structure constituted by triangles is used like the first embodiment, the notched structure may be alternatively constituted by trapezoids, elliptical arcs with varying curvature or parallelograms. Instead of providing a notched structure in the horizontal direction as shown in FIG. 2, a notched structure may be added in a direction perpendicular to the central axis of the barrier.

It should be noted that if dw denotes a width of a notched structure and p denotes a size of one pixel, an aperture area dSn of the notched structure in one pixel and an aperture area dSo of a diagonal slant barrier having a minimum aperture width hmin in one pixel may be expressed as (Expression 2), like the first embodiment. This is applicable regardless of the presence of a gap or alike. Even if left and right notch widths dwL, dwR vary, the aperture area S in one pixel in the vertical direction remains unchanged as long as dwL+dwR=dw×2 is satisfied.

A period of the notched structure is determined by candidate values that are adjusted by a method similar to the first embodiment. In other words, this moiré reduction effect is dependent on a pixel structure of sub-pixels in the vertical direction. Therefore, when a sub-pixel is divided by t, it may be preferable that the period is no more than a size obtained by the number of divisions nn of t (the number of pixel regions)+2 (black matrix regions)+t−1 (auxiliary electrode regions) to the left or right of an aperture. However, as shown in the first embodiment, in consideration of the influence of manufacturing errors, it may be preferable that a value nnd, which is a quotient of a sub-pixel size p in the vertical direction divided by the notch period ds, is a value that is apart from a vicinity of an integer. If possible, a notch period, which is close to an intermediate value of consecutive integer ratios nn1 and nn1+1 or nn1−1 and nn1, is more favorable since the influence of manufacturing errors may be almost totally eliminated.

A notched structure barrier pattern obtained by each barrier parameter may be evaluated by a simulation or alike using a period dso of a selected/determined notched structure. A moiré pattern (bright-dark pattern) visible from a predetermined observing position U(xc, yc) is estimated for each parameter vp[i]=(α[i], β[i], ds[i], hmax[i], hmin[i], dp[i], dds[i], kdsR[i], and Ave_rh[i]) of a barrier pattern having a notched structure. It is assumed that a proper viewing distance dlen, a barrier-panel distance gap, a pixel size p, a sub-pixel size sp, and a parallax number num are set by default. Although some parameters including the average aperture ratio Ave_rh[i]=Aveh0, the barrier inclination angle α[i]=α0, and the minimum aperture width hmin[i]=hmin0 in a single pixel size (vertical direction) that is an object are often fixed as a panel pixel structure or design values, variable parameters may be adopted instead. The maximum aperture width hmax, in other words, the width dw of the notched structure may vary. The variation may be added as a parameter such as kdw. Among the barrier parameters, the notch period ds[i] is set to adjusted dso and is not an adjustment object. Estimating/evaluating a moiré (bright-dark) pattern by a predetermined numerical operation (using a tool capable of calculating a light trajectory estimate or alike) using an object parameter vp obtained in this manner and optimizing the barrier pattern itself enables a pattern, which creates a comparable crosstalk amount but achieves further moiré reduction, to be designed.

### Modification Example 3

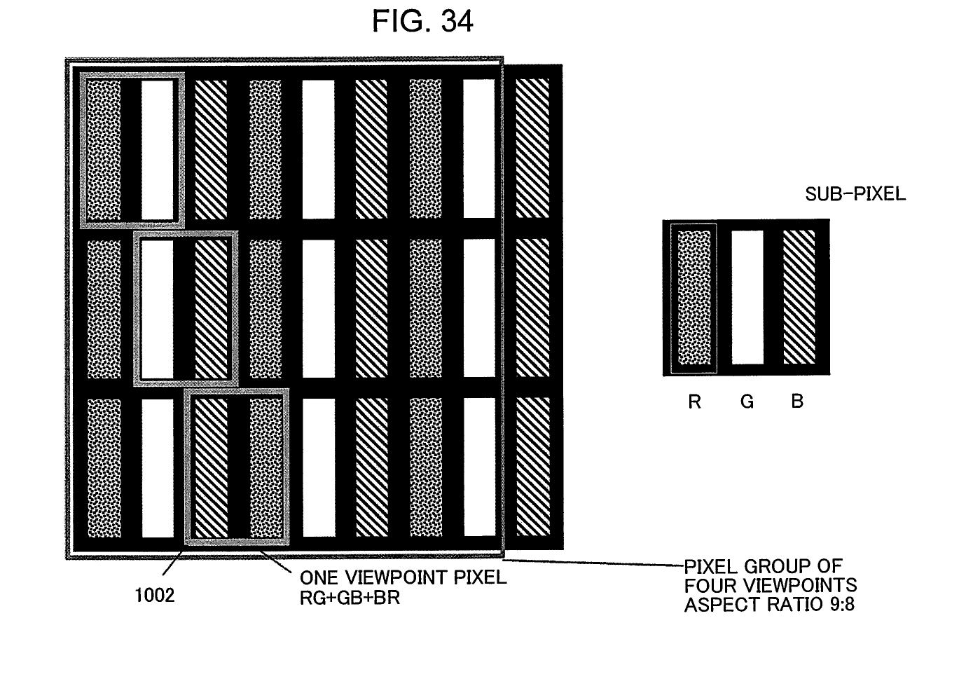

As a configuration similar to the modification example 1 of the aforementioned first embodiment, a device, which alternately arranges parallax images in sub-pixel units per two image rows (pixel arrangement example 1) and has a step barrier aperture 2 with an inclination of 3:1 (in a case of four parallaxes) is described with reference to FIGS. 1 and 34. The device is configured as shown in FIG. 1. The pixel arrangement is shown in FIG. 34. Parallax images are alternately arranged in sub-pixel units per two image rows. An aperture is provided with a step barrier having a horizontal aperture width bh of sub-pixel sp×2 and a vertical aperture width equal to pixel width sp×3. In this case, inclination is 3:1. Like the first embodiment, the proper viewing distance is shortened to ½ when the distance d between the panel and the barrier remains the same as the conventional example 1. Meanwhile, as apparent from FIG. 34, the descriptions “since one viewpoint pixel is constituted by RG+GB+BR, color balance does not deteriorate” and “even when the observer moves slightly to the left or right, B+G+R of an adjacent pixel becomes simultaneously visible (not shown)” hold true. Since the aperture width is equal to two sub-pixels, moiré is conceivably reduced. In the case of four parallaxes, since the horizontal and vertical proportions approach each other in pixel group units of one parallax, there is an advantage that “striped feel” is reduced. It should be noted that crosstalk is less likely to vary from a conventional step barrier, which is alternately arranged in one sub-pixel units and has an inclination of 3:1, even in this case.

### Third Embodiment

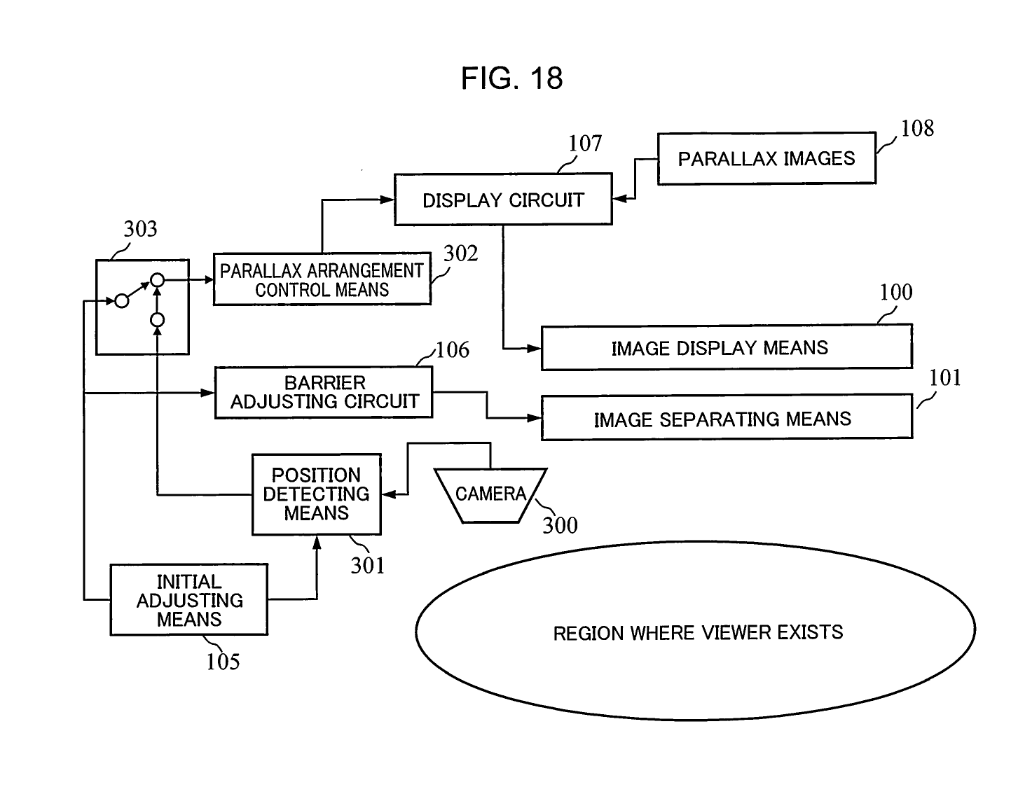

The third embodiment of the present invention is described with reference to FIGS. 18 to 25. In addition to the first or second invention, a device, which changes an alternate arrangement combination of image rows extracted from each parallax image in response to a viewer position obtained from a position detecting means configured to detect a position of the head or eyes of a viewer, is described in this embodiment.

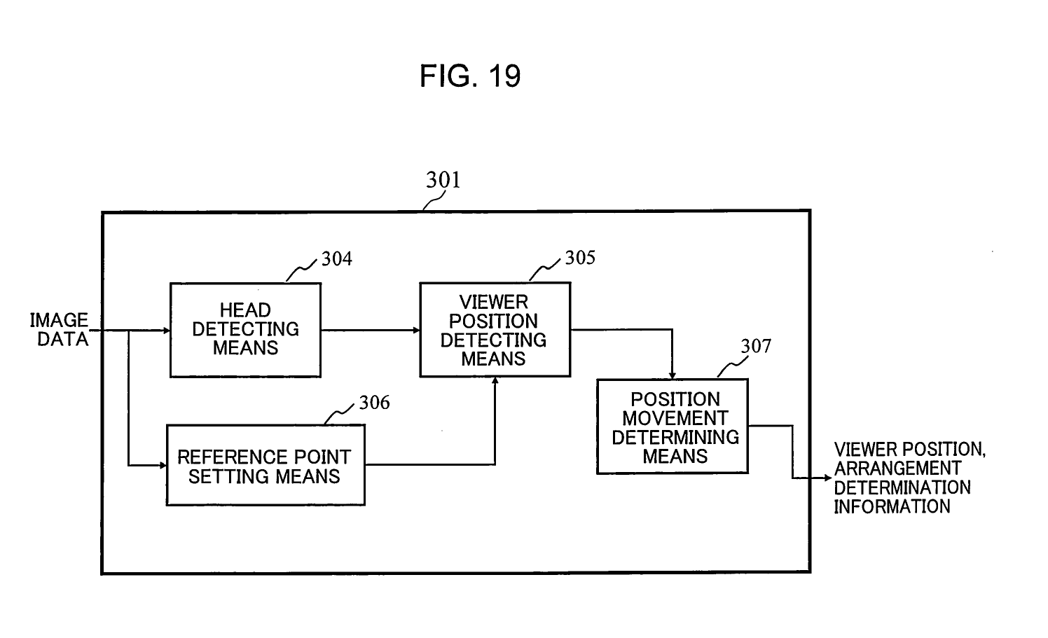

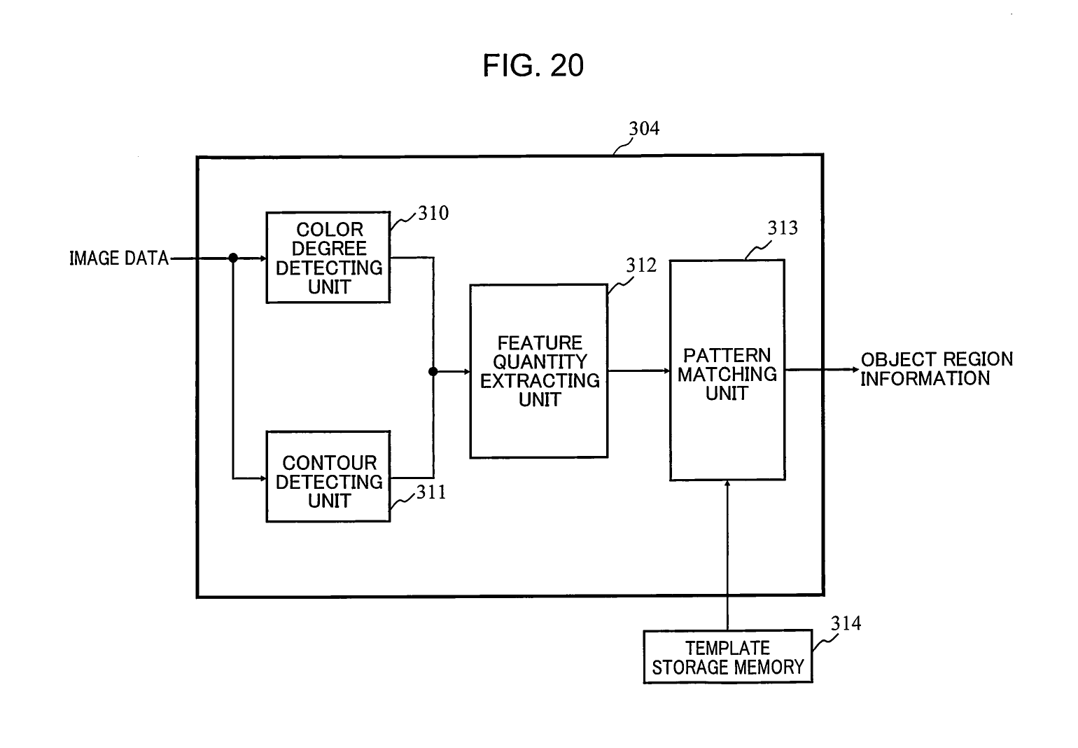

FIG. 18 shows a configuration of an image display device as the third embodiment of the present invention. FIG. 19 shows a configuration of the position detecting means inside the image display device as the embodiment of the present invention. FIG. 20 shows a configuration of a head detecting means inside the position detecting means. The image display device as the third embodiment of the present invention is described with reference to these drawings.

As shown in FIG. 18, the image display device includes a camera 300 for capturing images of a region, in which a viewer exists, a position detecting means 301, which detects a position variation of the viewer on the basis of the images, an initial adjusting means 105 which adjusts parameters for position detection and a display device, a parallax barrier and alike at the initial installation in a living room or alike, a two-dimensional display means 100 which displays a two-dimensional parallax image, a display circuit 107 of the two-dimensional display means 100, a barrier forming means 101 which transmits image light from the two-dimensional display means 100 through an aperture or shields image light from the two-dimensional display means 100 to present a parallax image at a predetermined position, a barrier control circuit 106, which controls the barrier, a parallax arrangement control means 103, which controls optimization of an arrangement of parallax images displayed on the two-dimensional display means 100 based on a result of 102, and parallax images 108 displayed on the two-dimensional display means 100 through the display circuit. It should be noted that if the parallax barrier 101 is made of a thin film or alike, since the parallax barrier 101 constitutes a fixed barrier, it is assumed that adjustment to a barrier position or a pitch are not performed by the initial adjusting means 105. In this case, the barrier control circuit 106 performs control to make an entire film surface transmissive or to enable a barrier (implement aperture and shielding). A device (such as a TFT liquid crystal panel) capable of varying shielding and aperture (light transmittance) when a voltage or alike is applied may be used.

Based on images captured by the camera 300 and a result of the position detecting means 301, parameters for position detection and a display device, a parallax barrier and alike are adjusted upon initial installation in a living room or alike by the initial adjusting means 105. In this case, with an active parallax barrier constituted by a TFT liquid crystal panel or alike, adjustment to a barrier pitch width or a barrier position at a predetermined proper viewing distance is performed (positional control of an aperture portion and a shielded portion is performed per pixel or sub-pixel basis). For adjustment to parameters related to position detection, adjustment to a luminance distribution/color distribution in captured images or adjustment to a threshold parameter in pattern matching (to be described later) is performed using camera images which show a person facing the front at a predetermined distance so that the face of the person may be extracted. As adjustment to a reference value for calculating a distance among a few viewers, a relative ratio amount RFace between a size FLEN of a reference face image in an image database (template storage memory) 314 and a size len of an extracted front face image is also obtained.

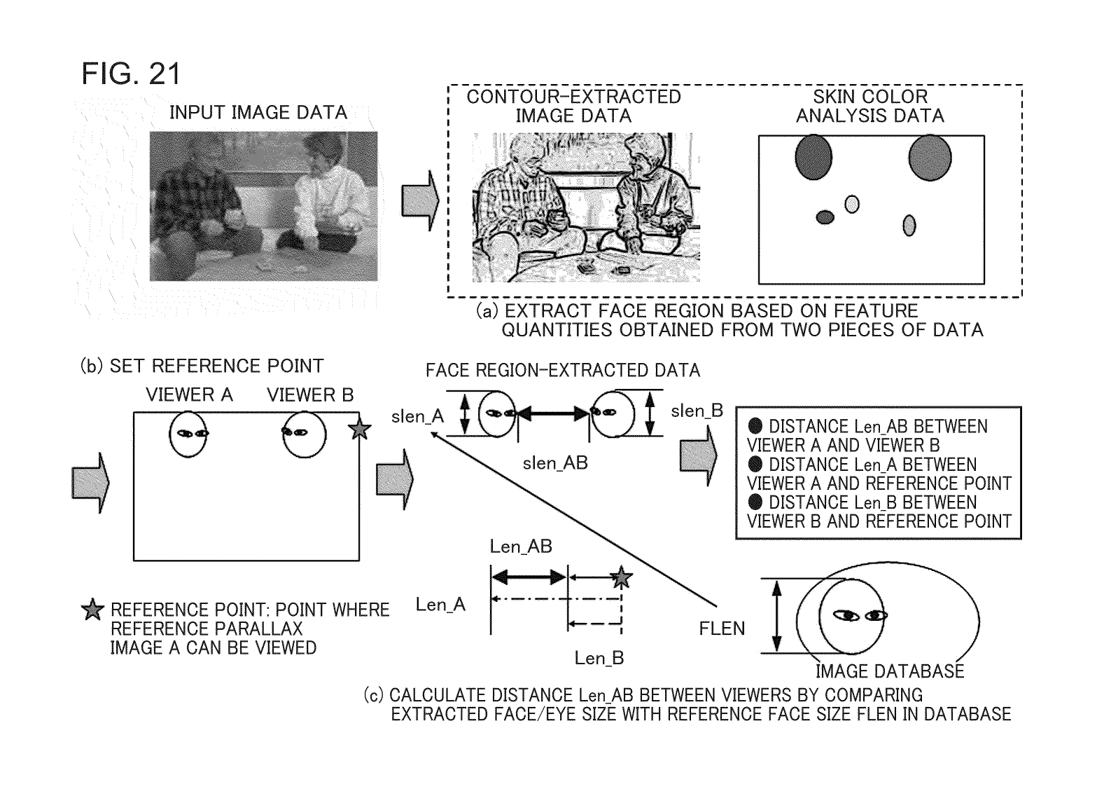

Meanwhile, stereoscopic image viewing evaluation using a test image from a proper viewing distance is performed. Based on visibility and a degree of blur/fusion, tuning or alike of gradation characteristics using the display circuit and parallax amount control (intensity control or adjustment to a horizontal shift amount using a linear coefficient) within a representative LR parallax image are conducted. This corresponds to adjustment to make a reference parallax image A visible at a reference point shown in FIG. 21.

In order to conduct such adjustment, position detection processes, which are particularly performed in order to enhance position detecting accuracy, are conducted as shown in FIG. 21. An image of a region in which a viewer is assumed to be present is captured by the camera 300 at first. A view angle has to be satisfied so that the region (e.g. in the case of a living room, a region with a viewing angle of 100 degrees and a viewing distance within 1.5 m to 6 m or 7 m from a TV) is captured. The head detecting means 304 extracts the head of a person in the image (FIG. 21(a)) from the image. A reference point setting means 306 sets a reference point to be used for detecting relative magnitude in the image (FIG. 21(b)). Next, as shown in FIG. 21(c), the viewer position detecting means 305 detects the heads of two persons A and B, and calculates a distance Len_AB between the viewers A, B, a distance Len_A between the viewer A and the reference point, and a distance Len_B between the viewer B and the reference point. In this case, as shown in FIG. 21(c), the size FLEN of the reference face image stored in an image database 188 is compared with a representative value of an extracted size slen_A of the person A and an extracted size slen_B of the person B to obtain the relative ratio amount RFace. The value is calculated as expressed in (Expression 4) as a coefficient of slen_AB, slen_A and slen_B obtained in the image. As for the extracted size of the person to be compared with FLEN, if there is a reference face image A prepared in advance, corresponding extracted slen_A may be used for comparison. Alternatively, an average value of slen_A and slen_B may be compared with FLEN.

[Expression 4]

Len_{—}A=slen_{—}A×RFace

Len_{—}B=slen_{—}B×RFace (4)

Len_{—}AB=slen_{—}AB×RFace

Finally, a position movement determining means 307 determines whether or not movement has occurred on the basis of variations dLenAB, dLenA, and dLenB of Len_AB, Len_A, and Len_B which are pieces of position information of the viewers A and B prior to a predetermined time. In this case, since a distance between parallax images is the interocular distance Leye, a threshold is set to Leye/2 as a magnitude which causes little crosstalk. In other words, determination that movement has occurred is made when two or more variations among dLenAB, dLenA, and dLenB exceed Leye/2, so that the position detecting means 301 outputs the viewer position information (Len_AB, Len_A, and Len_B) and signals which instruct parallax image arrangement control to be executed.

For example, the head detecting means 304 is configured as shown in FIG. 20. It should be noted that although the template storage memory 314 may be constituted by an external memory outside the head detecting means 304 as shown in FIG. 20, the template storage memory 314 may be included in the head detecting means 304, alternatively.

A contour detecting unit 311 acquires contour information from input color image signals (image data). Processes by the contour detecting unit 311 are described in detail below.

The contour detecting unit 311 determines a differential vector vd(i,j)(xd(i,j),yd(i,j)) of each pixel (ij) in the image according to (Expression 6) based on two-dimensional filtering using a 3×3 two-dimensional filter expressed by (Expression 5). The contour detecting unit 311 determines a magnitude stv(i,j) of the differential vector vd(i,j) according to stv(i,j)=(xd(i,j)×xd(i,j)+yd(i,j)×yd(i,j))̂0.5.

The contour detecting unit 311 performs contour pixel extraction by comparing each pixel (i,j)stv(i,j) as expressed by (Expression 7) using a predetermined threshold TH2. It should be noted that (Expression 7) is used to perform binarization for indicating whether or not a pixel in an image formed by color image signals is a pixel included in a contour, wherein E(i,j)=1 indicates that the pixel (i,j) is included in the contour.

$$\begin{matrix}[ Expression 5 ] & \\ fx = [ \begin{matrix}{fx}_{00} & {fx}_{10} & {fx}_{20} \\ {fx}_{01} & {fx}_{11} & {fx}_{21} \\ {fx}_{02} & {fx}_{12} & {fx}_{22}\end{matrix} ] = [ \begin{matrix}- 1 & 0 & 1 \\ - 2 & 0 & 2 \\ - 1 & 0 & 1\end{matrix} ] , \\ fy = [ \begin{matrix}{fy}_{00} & {fy}_{10} & {fy}_{20} \\ {fy}_{01} & {fy}_{11} & {fy}_{21} \\ {fy}_{02} & {fy}_{12} & {fy}_{22}\end{matrix} ] = [ \begin{matrix}- 1 & - 2 & - 1 \\ 0 & 0 & 0 \\ 1 & 2 & 1\end{matrix} ] & ( 5 ) \\ [ Expression 6 ] & \\ xd ( i , j ) = {\sum }_{n = - 1}^{1} {\sum }_{m = - 1}^{1} {fx}_{n + 1 m + 1} \cdot k ( i - n , j - m ) \\ y d ( i , j ) = {\sum }_{n = - 1}^{1} {\sum }_{m = - 1}^{1} {fy}_{n + 1 m + 1} \cdot k ( i - n , j - m ) & ( 6 ) \\ [ Expression 7 ] & \\ E ( i , j ) = [ \begin{matrix}1 & if ( stv ( i , j ) \geq TH 2 ) \\ 0 & if ( stv ( i , j ) < TH 2 )\end{matrix} & ( 7 )\end{matrix}$$

In this manner, contour information E(i,j) (hereinafter, also simply referred to as “contour information Ei”) obtained by the contour detecting unit 314 is output to a feature quantity extracting unit 186. A color degree detecting unit 310 calculates a degree of skin color of pixels in respective clusters of pixels classified according to color distribution. Subsequently, information is obtained so that a cluster region which includes a greater number of pixels with high degrees of skin color has an output of 1.0. The color degree information is also handed over to a feature quantity extracting unit 312 which determines a degree of humanness FHi(i,j) based on feature quantities derived from the contour information and the degree of skin color. The calculation may involve a linear combination of the two feature quantities or a non-linear transformation of the two feature quantities. For parts in the contour information Ei with a high degree of skin color, Ei may be output as-is as a degree of humanness FHi(i,j) whereas parts with a low degree of skin color may be multiplied by a coefficient, which decreases the contour information Ei, and then output as a degree of humanness FHi(i,j). Alternatively, the degree of humanness FHi(i,j) may be determined solely on the basis of the contour information Ei without using the degree of skin color. A pattern matching unit 313 performs object region extraction by performing pattern matching of the degree of humanness FHi obtained by the feature quantity extracting unit 312 with shape data of an object region in the template storage memory 314 prepared in advance. Examples of an object region subjected to object region extraction include a face region, a person region (upper body or whole body), a facial part region such as an eye, the nose, or the mouth and alike. When the object region is a face region, standard shape data of a face region (alternatively, pieces of shape data or pieces of shape data corresponding to a few directions) is stored in the template storage memory 314. When the object region is a person region, standard shape data of a person region (alternatively, pieces of shape data, pieces of shape data corresponding to a few directions, or shape data of the upper body or the whole body) is stored in the template storage memory 314. When the object region is a part region such as an eye, the nose or the mouth, standard shape data of each part region is stored in the template storage memory 314. As described above, by performing pattern matching between shape data Tp[k, s] (p=1, . . . , Pnum) (k=0, 1, . . . , Wp−1) (s=0, 1, . . . , Hp−1) stored in the template storage memory 314 and feature quantity information FH(ij) of each pixel (i,j), a corresponding region (object region information) is extracted by the pattern matching unit 313. It should be noted that Pnum denotes a number of templates and each of Wp and Hp denotes a number of horizontal pixels and a number of vertical pixels in a rectangular template.

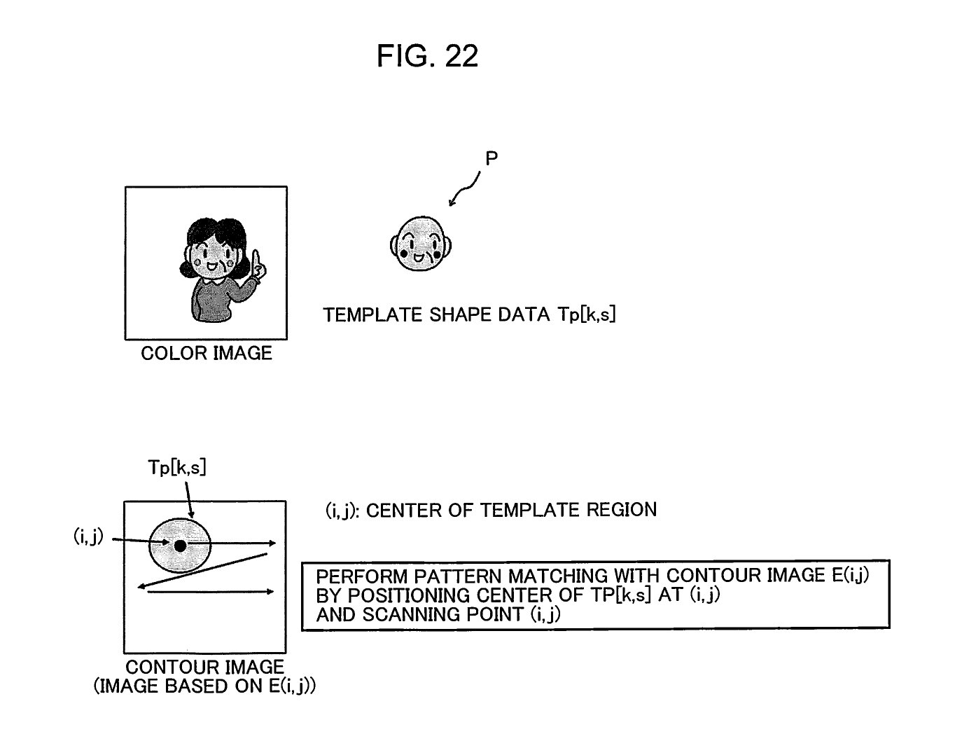

Although there are various methods by which the pattern matching unit 313 may execute pattern matching, FIG. 22 shows a simple exemplary method. The method shown in FIG. 22 is described. FIG. 22 is a schematic view for illustrating an example of a pattern matching method.

For a template p, a rectangular region candidate SR[i, j, Wp, Hp] with a horizontal width of Wp and a vertical width of Hp is set at the center of a pixel (i,j).

Based on contour information E(i,j) in the rectangular region candidate SR[i, j, Wp, Hp] and shape data Tp[k, s]((k=0, Wp−1) (s=0, 1, . . . , Hp−1)) stored in the template storage memory 314, an evaluation function R(i, j, p) such as that expressed by (Expression 8) is obtained.

Next, as expressed by (Expression 9), MR having a maximum evaluation function R(i, j, p) for the template p and the pixel (i,j) is obtained. In (Expression 9), MAX represents obtaining a maximum value of R(i, j, p) for the pixel (i,j) and the template p. If the maximum value MR is no less than a predetermined threshold THMR, a rectangular region candidate SR[i, j, Wp, Hp] corresponding to the maximum value MR is extracted as a desired rectangular region candidate BestSR[i, j, W, H].

By comparing with the predetermined threshold THMR in this manner, matching to noise and alike may be suppressed. It should be noted that if the maximum value MR is smaller than the threshold THMR, it is assumed that there is no object region, and then input image information [width/2, height/2, width, height] is output as object region information BestSR[i, j, W, H]. In this case, width represents a number of horizontal pixels in the input image and height represents a number of vertical pixels in the input image.

$$\begin{matrix} [ Expression 8 ] & \\ R ( i , j , p ) = {\sum }_{k = 0}^{Wp - 1} {\sum }_{s = 0}^{Hp - 1} Tp [ k , s ] \cdot E ( i - Wp / 2 + k , j - Hp / 2 + s ) & ( 8 ) \\ [ Expression 9 ] & \\ BestSR [ i , j , W , H ] = \{ SR [ i , j , Wp , Hp ] \vert MR = {max}_{( i , j ) , p} \{ R ( i , j , p ) \} , MR \geq THMR \} & ( 9 )\end{matrix}$$

As described above, object region information BestSR[i, j, W, H] acquired by the pattern matching unit 313 is output as object region information by the head detecting means 304.

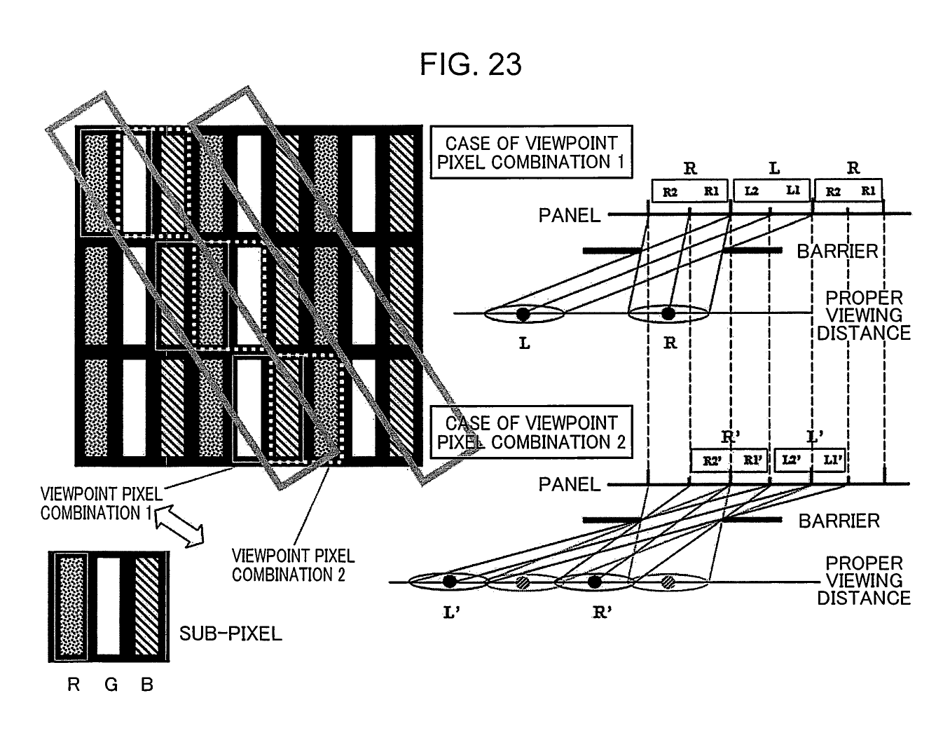

In this manner, when signals indicating determination of position movement are output by the position detecting means 301, a parallax arrangement control means 302 performs proper arrangement of parallax images displayed on the two-dimensional display means 100. FIG. 23 shows the performed proper arrangement. Although FIGS. 23 to 25 show a case of parallax number nn=2, an expansion to multiple views is also possible. FIG. 23 shows an example which alternately arranges two parallax images in sub-pixel units per two image rows according to the first embodiment of the present invention and has a step barrier aperture with an inclination of 3:2. A top right diagram shows how left-eye images L (L1 and L2) and right-eye images R (R1 and R2) respectively corresponding to the left and right eyes at predetermined positions reach the left and right eyes through a fixed barrier using a viewpoint pixel combination 1. In this case, since two parallax images are arranged in sub-pixel units per two image rows, L1 denotes a left-eye pixel at (x,y) and L2 denotes a left-eye pixel at (x+1,y). Likewise, R1 denotes a right-eye pixel at (x,y) and R2 denotes a right-eye pixel at (x+1,y). On the other hand, a bottom right diagram in FIG. 23 shows a case where the head has moved left, so that the left eye has moved to L′ and the right eye has moved to R′. In other words, this corresponds to a case where the head has been moved to a midway point between left eye and right eye positions designed as a proper viewing position. In this case, if the viewpoint pixel combination 1 shown in the top right diagram is adopted as-is, the right-eye pixel R1 and the left-eye pixel L2 simultaneously enter the right eye. The left-eye pixel L1 and the right-eye pixel R2 simultaneously enter the left eye. Consequently, a three-dimensional image may not be properly viewed. In this consideration, by changing the pixel arrangement to a viewpoint pixel combination 2, corresponding parallax images may be viewed even at the right-eye position R′ and the left-eye position L′ shown in the bottom right diagram. The parallax arrangement control means 302 switches between the two parallax pixel arrangement combinations in response to head positions to achieve natural stereoscopic display in the case of two parallax images. By combining this function with the first or second embodiment, image distortion due to head movement may be improved with retaining the effects (1) to (3) described below.

(1) When the distance d between the barrier and the panel is the same value, the proper viewing distance L may be shortened than usual.

(2) When aperture width bh=2×sp, in comparison to a conventional alternate arrangement per an image row, moiré is more likely to be reduced due to the aperture width corresponding to two pixels with keeping the proportion of pixels included in an adjacent parallax image which becomes visible to a comparable level. By adding a notched structure so that the average aperture width Avebh becomes smaller than 2×sp (e.g. Avebh=1.6×sp), moiré may be reduced to a level comparable to a case where the aperture width is wider (e.g. when aperture width bh=2×sp) with suppressing crosstalk.

(3) Color balance at one viewpoint pixel conceivably does not deteriorate. Even when an observer moves slightly to the left or right, color moiré is less likely to occur.

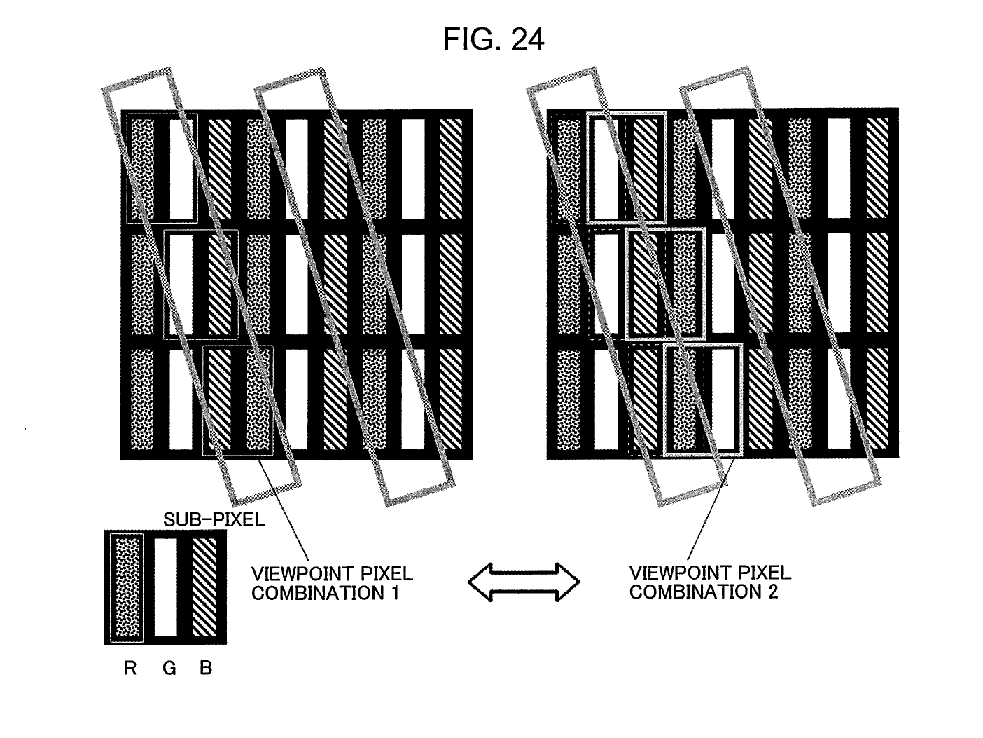

As a modification of the present embodiment, there may be a possible case where two parallax images are alternately arranged in sub-pixel units per two image rows according to the second embodiment as shown in FIG. 24 and a step barrier aperture with an inclination of 3:1 is provided. Even in this case, the parallax pixel combination 1 and the parallax pixel combination 2 are switched in accordance with head positions, like FIG. 23. In this case, by setting the barrier inclination angle to 3:1, crosstalk may be reduced in comparison to the first embodiment. Although moiré conversely increases to a certain degree, moiré may be reduced by combination with a notched structure. As described in the modification example 2 of the present embodiment, by providing a notched structure that does not exceed (maximum) aperture width bhmax=2×sp, crosstalk due to pixels included in an adjacent parallax image becoming visible is minimized. Meanwhile, moiré may be reduced due to the effect of notches.

It should be noted that the period of the notched structure (left and right periods are the same if symmetrical whereas left and right periods are different from each other if asymmetrical) is dependent on a pixel structure of sub-pixels in the vertical direction. When a sub-pixel is divided by t, it may be preferable that the period is no greater than a size obtained by the number of divisions nn of t (the number of pixel regions)+2 (black matrix regions)+t−1 (auxiliary electrode regions) to the left or right of an aperture. However, in consideration of the influence of manufacturing errors, a value nnd, which is a quotient of a sub-pixel size p in the vertical direction divided by the notch period ds, is favorably a value that is apart from a vicinity of an integer. If possible, a notch period, which is close to an intermediate value of consecutive integer ratios nn1 and nn1+1 or nn1−1 and nn1 is more favorable since the influence of manufacturing errors may be almost totally eliminated.

Although a notched structure constituted by triangles is used in the same manner as described above, the notched structure may be alternatively constituted by trapezoids, elliptical arcs with varying curvature or parallelograms. Instead of providing a notched structure in the horizontal direction as shown in FIG. 6, a notched structure may be added in a direction perpendicular to the central axis of the barrier.

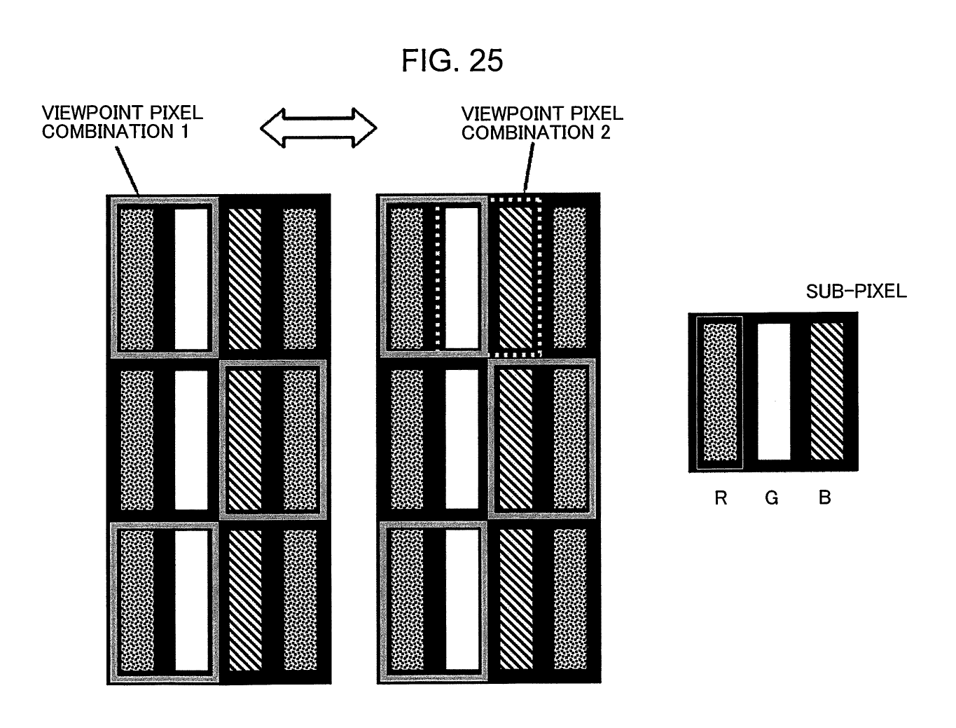

Although an example of a diagonal slant structure is described, the present embodiment may be applied to a diagonal step barrier in which rectangular shapes of sub-pixels are arranged in a diagonal direction like the modification of the first embodiment as shown in FIG. 25. The parallax pixel combinations 1 and 2 are switched in response to head positions like FIG. 23.

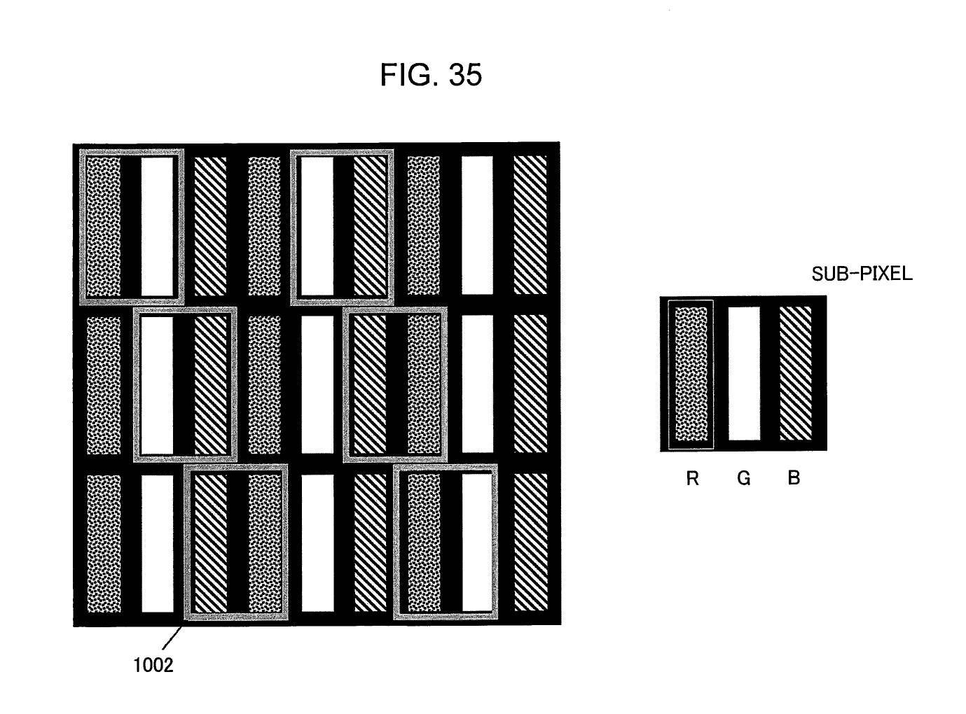

Although an example of a diagonal slant structure is described, the present embodiment may be applied to a diagonal step barrier in which rectangular shapes of sub-pixels are arranged in a diagonal direction like the modification of the second embodiment as shown in FIG. 35. The parallax pixel combination 1 and 2 are switched in response to head positions, like FIG. 24.

### Fourth Embodiment

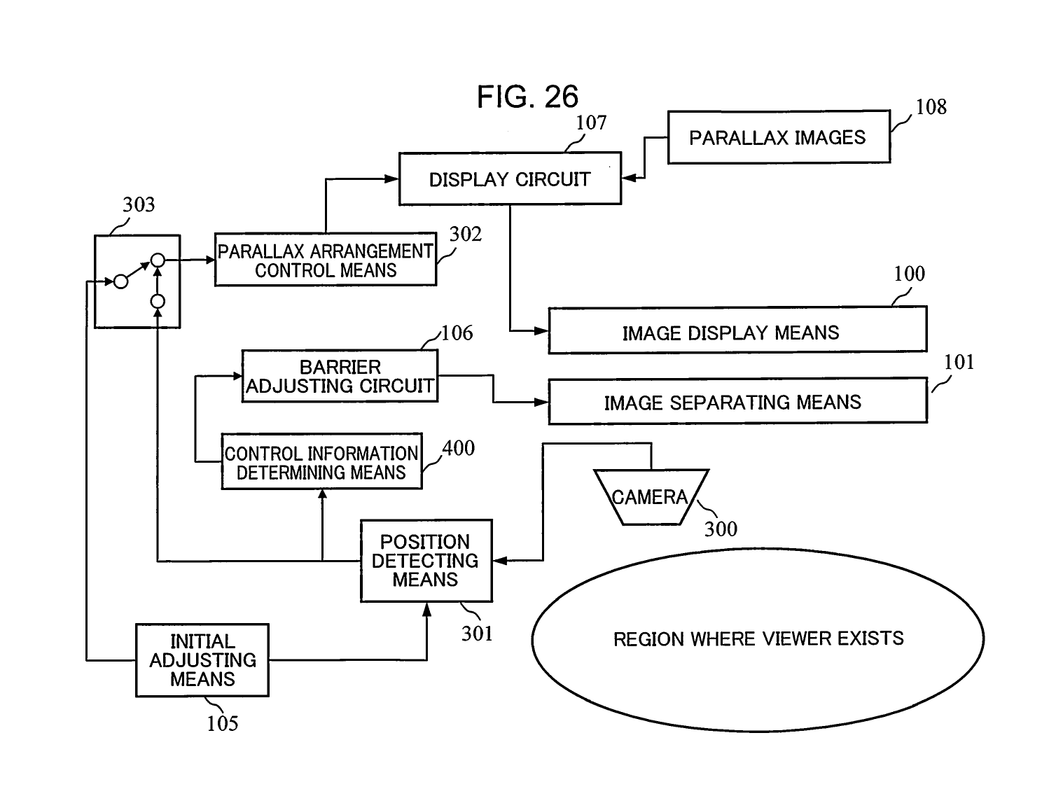

The fourth embodiment of the present invention is described with reference to FIGS. 26 to 28. In addition to the first to third inventions, an alternate arrangement combination of image rows extracted from each parallax image is changed in response to a viewer position obtained from a position detecting means configured to detect a position of the head or eyes of a viewer in the fourth embodiment. An aperture shape is formed by controlling transmittance of a region in which light transmittance is variably controlled in accordance with an inclination angle formed by the image rows and a width of the image rows of each of the arranged parallax images.

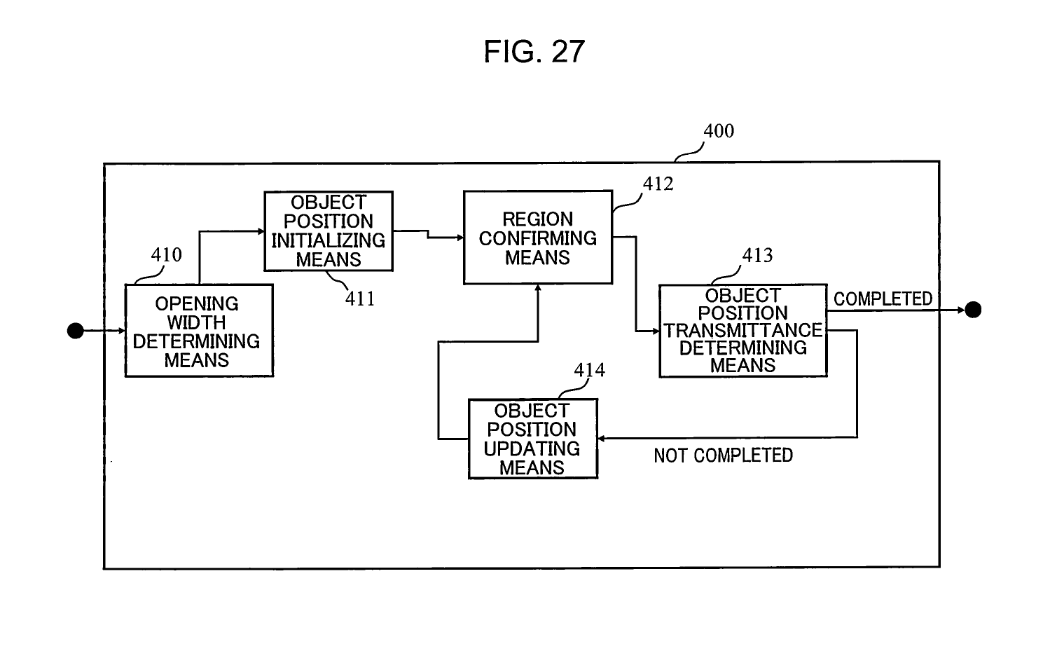

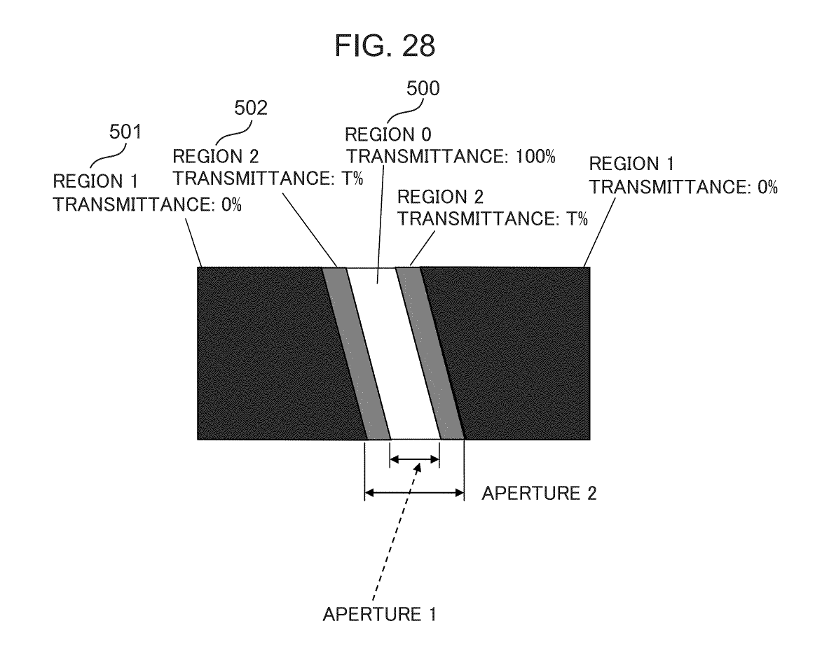

FIG. 26 shows a configuration of an image display device as the fourth embodiment of the present invention. FIG. 27 shows a configuration of a control information determining means 400. FIG. 28 schematically shows barrier adjustment with a slant barrier as a separating means. The image display device as the fourth embodiment of the present invention is described with reference to these drawings.

As shown in FIG. 26, the present fourth embodiment includes an initial adjusting means 105, which adjusts a display device, a parallax barrier and alike, an image display means 100, which displays a two-dimensional parallax image, a display circuit 107 of the image display means 100, an image separating means 101 such as a parallax barrier, which transmits image light from the image display means 100 through an aperture or shields image light from the image display means 100 to present a parallax image at a predetermined position, a barrier adjusting circuit 106, which adjusts a distance between the separating means and the image display means, a position of the separating means and alike, parallax composite images 108 displayed on the image display means 100 through the display circuit 107, a camera 300 for capturing an image of a region in which a viewer exists, a position detecting means 301, which detects positional variation of the viewer based on the image, and a control information determining means 400, which determines information when adjusting a barrier width or alike using liquid crystals or alike. The control information determining means 400 includes an aperture width determining means 410 which determines widths of apertures 1 and 2 shown in FIG. 27, an object position initializing means 411 which initializes a position in the horizontal direction, a region confirming means 412 which determines a belonging horizontal position of a current object from a region 0, a region 1 and a region 2 shown in FIG. 26, an object position transmittance determining means 413, which determines transmittance x % for each region, and an object position updating means 414, which updates an object position in the horizontal direction unless transmittance is determined for all positions in the horizontal direction. It should be noted that the aperture width determining means 410 may set two default values or two values selected in advance under conditions of a viewing environment for the widths of the apertures 1 and 2.

In the present embodiment, a parallax barrier as the image separating means includes regions 0 and 1 to switch between a transmitted state (a state where light transmittance is 100%) and a shielded state (a state where light transmittance is 0%), and a region 2 in which light transmittance may be variably controlled. The regions 0, 1, 2 are all constituted by a device (such as a TFT liquid crystal panel) in which a shielding/aperture ratio (light transmittance) may be varied under voltage application. It is assumed that voltage applied to the region 0 is adjusted so as to create a region in a transmitted state (transmittance 100%) and voltage applied to the region 1 is adjusted so as to create a region in a shielded state (transmittance 0%). On the other hand, the region 2 corresponds to a region in which a shielding ratio (T %) may be varied in response to an applied voltage.

In FIG. 28, when the transmittance T of the region 2 is 0% (shielded state), a state of the aperture 1 is created. In short, there is the state 1 to cause moiré. When the transmittance T of the region 2 is 100% (transmitted state), a state of the aperture 2 is created. In short, there is the state 2 to cause moiré. By varying voltage applied to the region 2, transmittance varies to cause transition between the moiré states 1 and 2. When the voltage applied to the region 2 is varied to set T to an appropriate value, a state where moiré is eliminated or significantly reduced may be achieved. For example, when a width of the aperture 1 is equal to a sub-pixel pitch and a width of the aperture 2 is equal to sub-pixel pitch×2, an average aperture ratio is sub-pixel pitch×1.5 if the transmittance T of the region 2 is T=50%. In this manner, by controlling the transmittance T % of the region 2, even if a width of an aperture capable of eliminating moiré is accurately derived, moiré may be eliminated or significantly reduced by controlling applied voltage after fabricating a parallax barrier. Even when a proper aperture width is accurately derived but the designed width is not accurately reproduced through manufacturing, moiré may be eliminated or significantly reduced by fabricating a parallax barrier in consideration of manufacturing accuracy so as to create the apertures 1 and 2 and by controlling applied voltage.

By adding this function to the third embodiment, when alternately arranging parallax images in sub-pixel units per two image rows according to the first to third embodiments, adjustment may be performed so as to reduce moiré/crosstalk by switching between different arrangements of the parallax images and varying barrier widths according to head movement. It should be noted that although a case where only the barrier width is adjusted by the control information determining means 400 is described, a position of the barrier itself may be moved to the left or right in the horizontal direction in response to movement of the head position. In this case, the barrier position is moved in the horizontal direction with maintaining the same barrier pitch. This may be achieved even when the parallax number nn is greater than 2.

Although a plasma display is described as image display means in the present embodiment, a liquid crystal display, an EL display or alike may be used instead.

Like liquid crystals, a device to change only the region 2 into a T % portion under voltage application may be used. In this case, the region 0 is opened to constantly create a transmitting state. A fixed device (a masked glass, film or alike) is arranged in the region 1 so as to constantly create a shielded state.

It should be noted that although a barrier structure is described on the basis of a slant (diagonal) barrier shape, a vertical striped barrier shape may be adopted instead.

### Fifth Embodiment

The fifth embodiment of the present invention is described with reference to FIGS. 1, 10 and 40 to 48. A stereoscopic image display device which combines the pixel arrangement example 2 according to the second embodiment shown in FIG. 10 to alternately arrange parallax images in sub-pixel units per two image rows and has a slant barrier aperture with an inclination of 10 to 15 degrees is described as the fifth embodiment.

The present invention is configured as shown in FIG. 1. The operations are similar to those of the first embodiment. FIG. 10 shows a pixel arrangement example such as that described in the second embodiment in which parallax images are alternately arranged in sub-pixel units per two image rows.

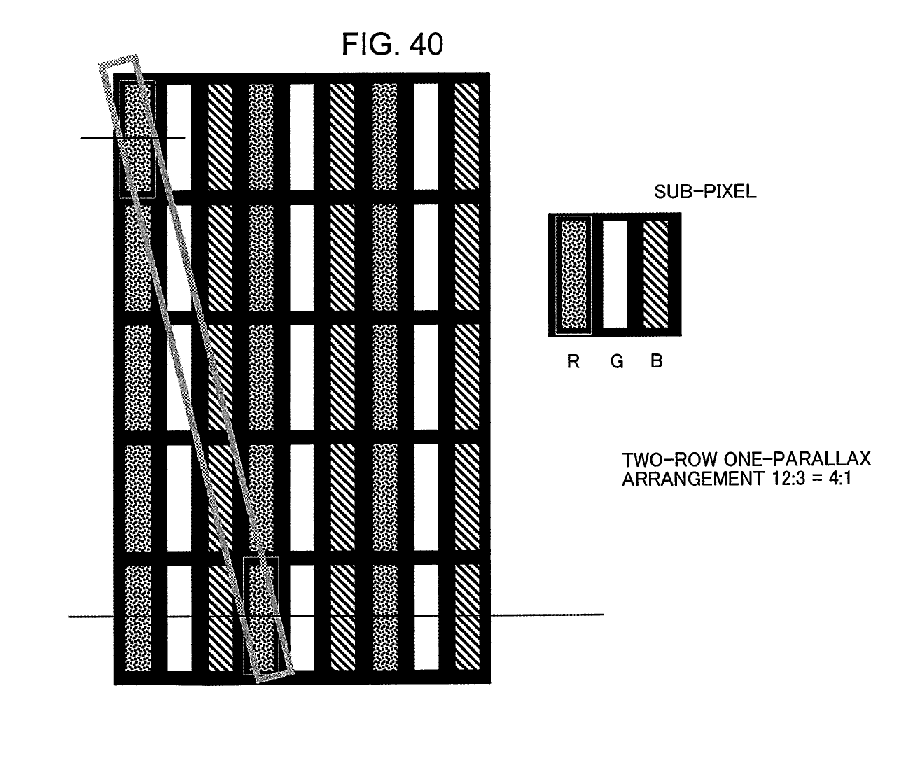

FIG. 40 shows an example which combines the pixel arrangement example according to the second embodiment to alternately arrange parallax images in sub-pixel units per two image rows with a 4:1 slant barrier (a slant barrier having an inclination of 14.04 degrees with respect to the vertical direction). In this case, it is assumed that a vertical size spy of a sub-pixel is three times as great as a horizontal size sph of a sub-pixel.

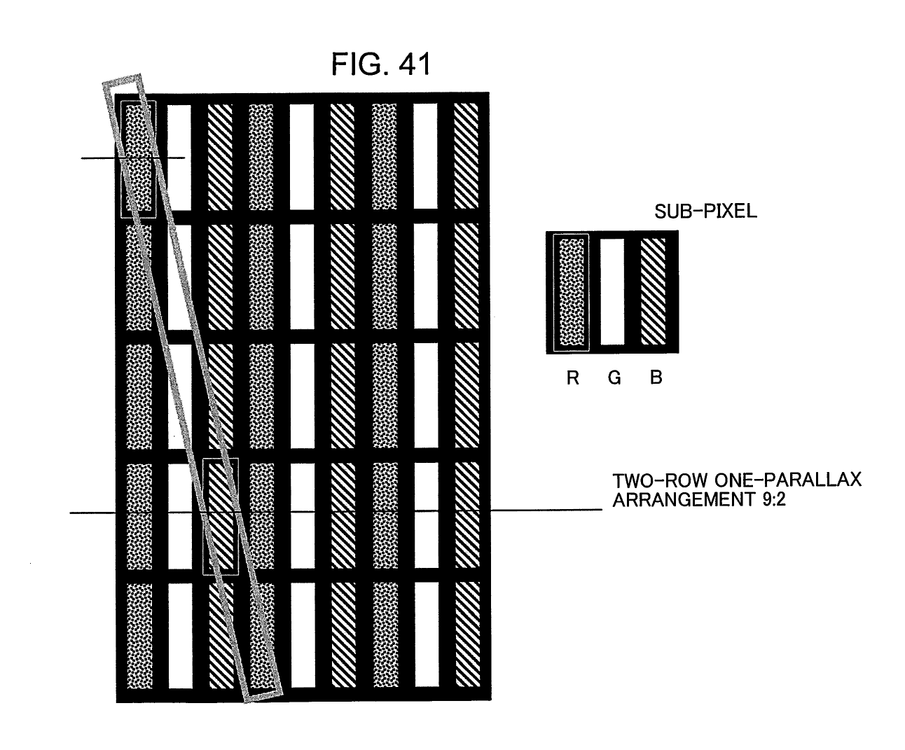

FIG. 41 shows an example which combines the pixel arrangement example according to the second embodiment to alternately arrange parallax images in sub-pixel units per two image rows with a 9:2 slant barrier (a slant barrier having an inclination of 12.52 degrees with respect to the vertical direction).

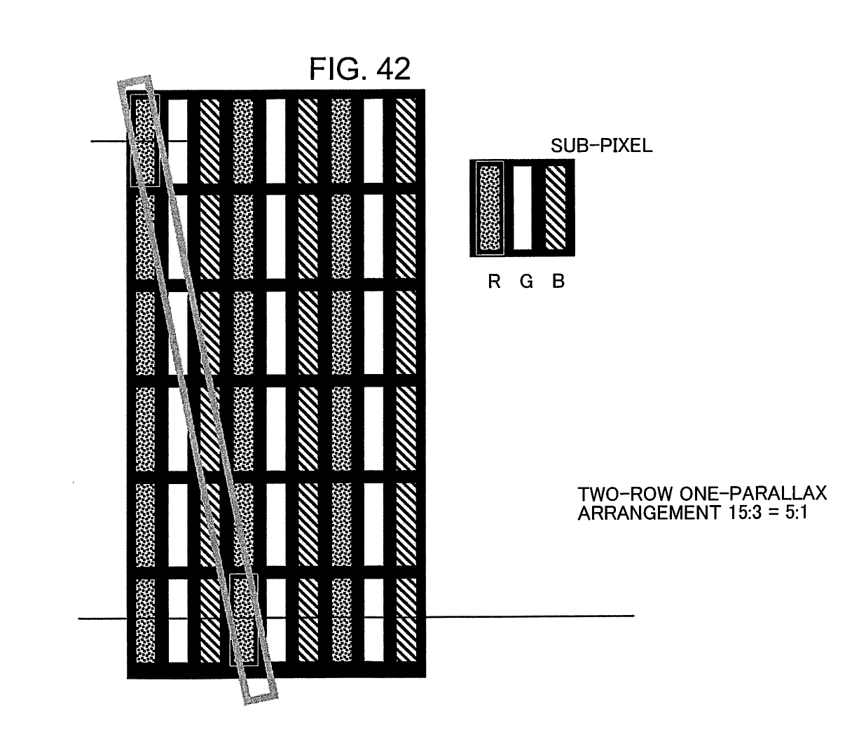

FIG. 42 shows an example which combines the pixel arrangement example according to the second embodiment to alternately arrange parallax images in sub-pixel units per two image rows with a 15:3 slant barrier (a slant barrier having an inclination of 11.31 degrees with respect to the vertical direction).

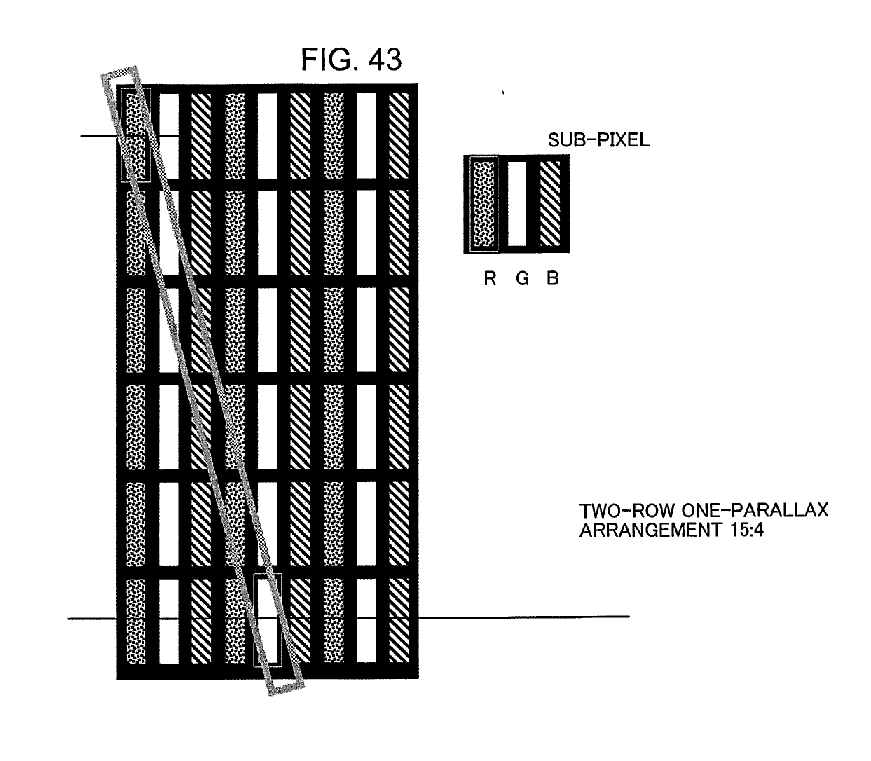

FIG. 43 shows an example which combines the pixel arrangement example according to the second embodiment to alternately arrange parallax images in sub-pixel units per two image rows with a 15:4 slant barrier (a slant barrier having an inclination of 14.93 degrees with respect to the vertical direction).

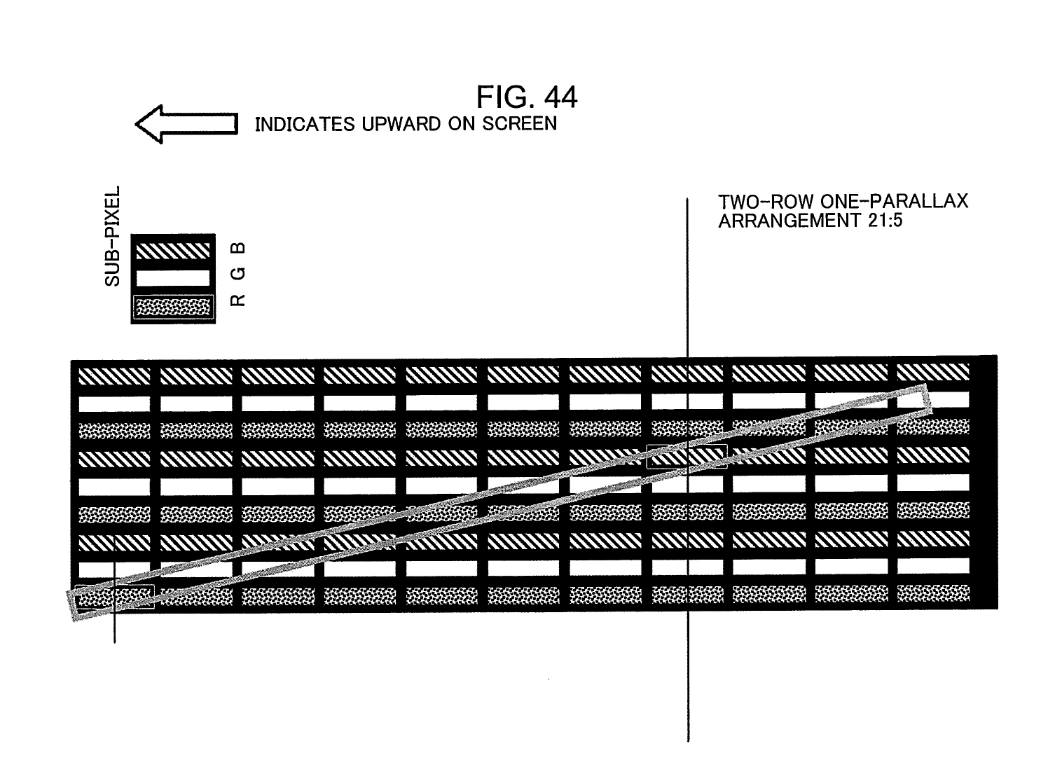

FIG. 44 shows an example which combines the pixel arrangement example according to the second embodiment to alternately arrange parallax images in sub-pixel units per two image rows with a 21:5 slant barrier (a slant barrier having an inclination of 13.39 degrees with respect to the vertical direction).

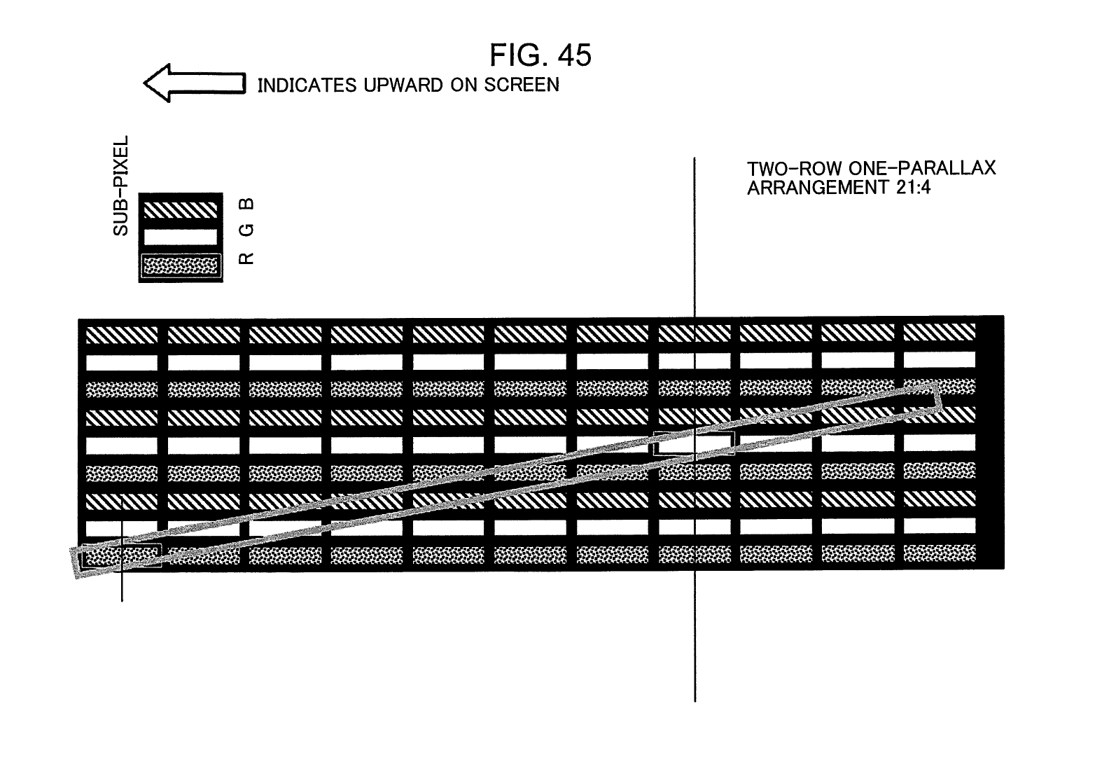

FIG. 45 shows an example which combines the pixel arrangement example according to the second embodiment to alternately arrange parallax images in sub-pixel units per two image rows with a 21:4 slant barrier (a slant barrier having an inclination of 10.78 degrees with respect to the vertical direction).

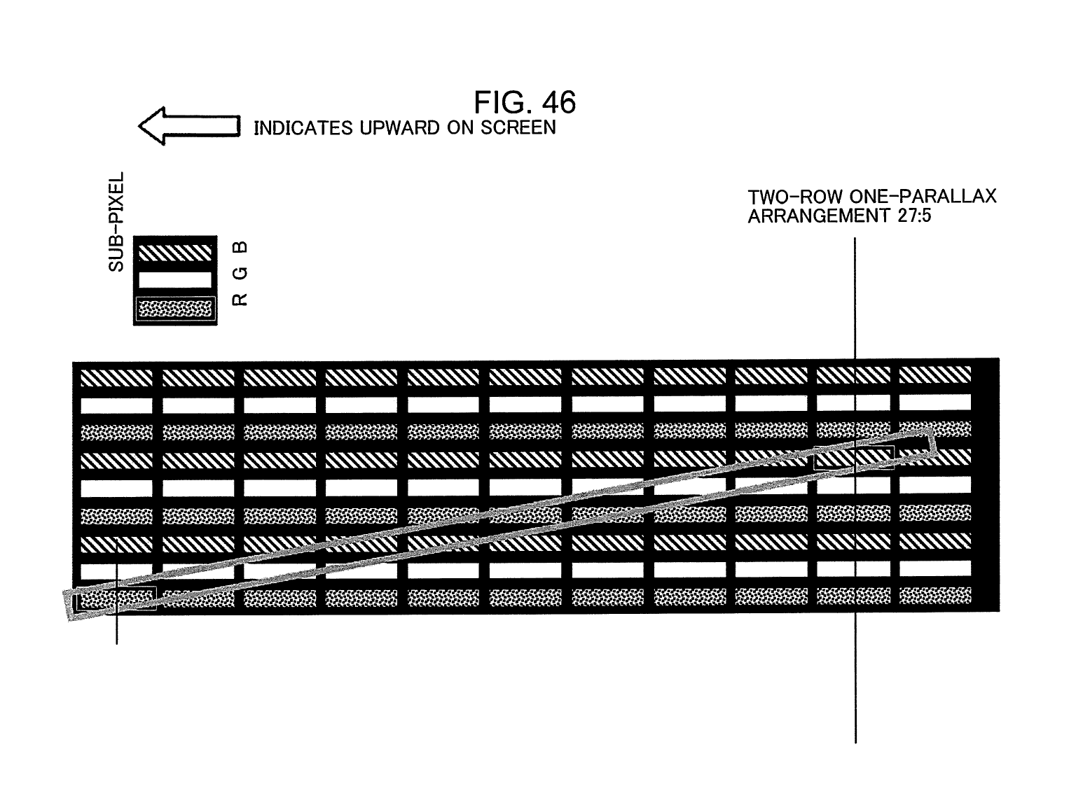

FIG. 46 shows an example which combines the pixel arrangement example according to the second embodiment to alternately arrange parallax images in sub-pixel units per two image rows with a 27:5 slant barrier (a slant barrier having an inclination of 10.49 degrees with respect to the vertical direction).

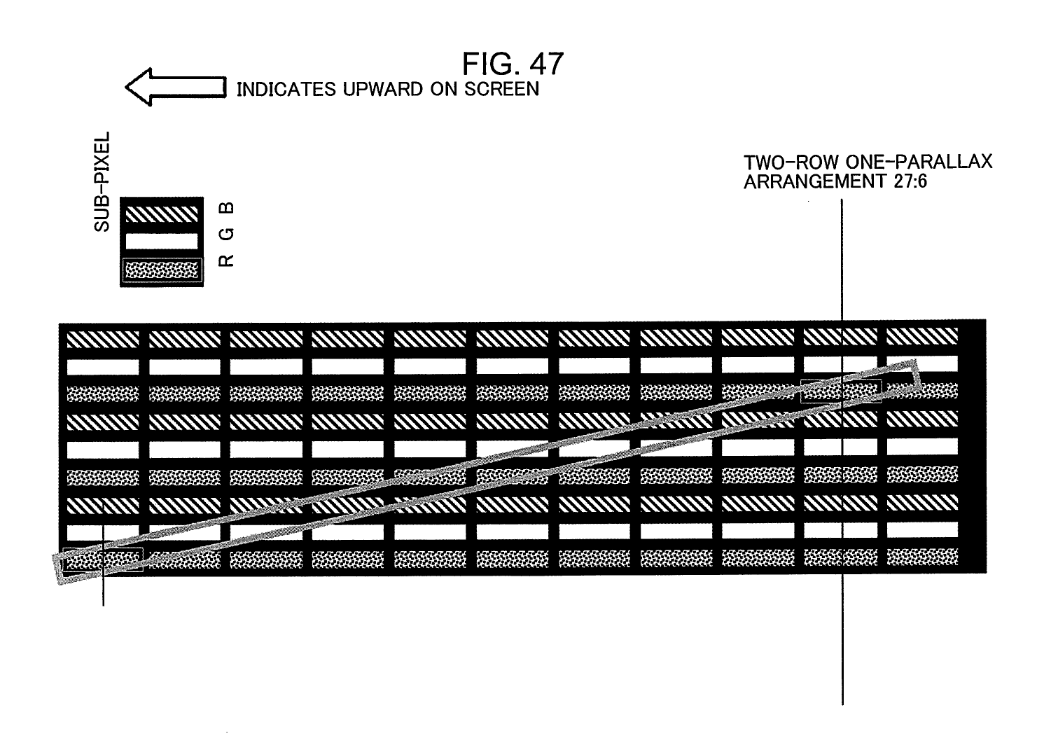

FIG. 47 shows an example which combines the pixel arrangement example according to the second embodiment to alternately arrange parallax images in sub-pixel units per two image rows with a 27:6 slant barrier (a slant barrier having an inclination of 12.52 degrees with respect to the vertical direction).

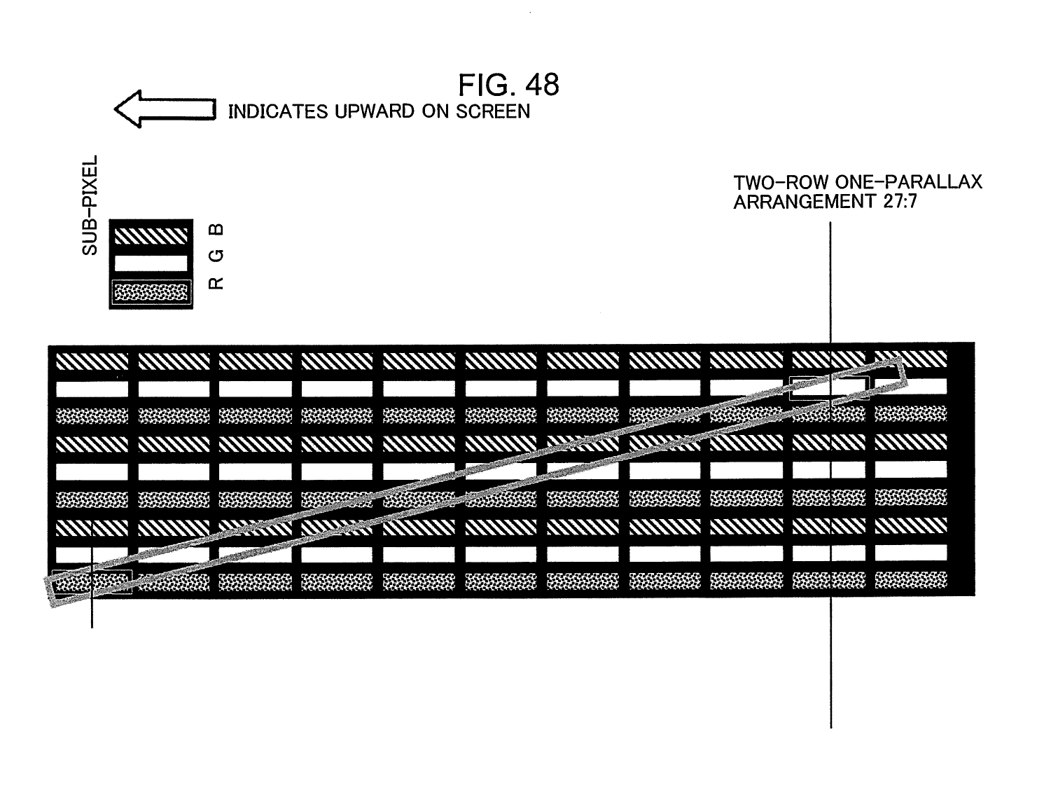

FIG. 48 shows an example which combines the pixel arrangement example according to the second embodiment to alternately arrange parallax images in sub-pixel units per two image rows with a 27:7 slant barrier (a slant barrier having an inclination of 14.53 degrees with respect to the vertical direction).

Since the drawings in FIGS. 44 to 48 are oriented so that upward in a direction perpendicular to the screen is represented by a direction of an arrow, a sub-pixel structure which has a normal horizontal size and a vertical size that is three times as great as the horizontal size is depicted as shown in FIGS. 40 to 43 and alike.

It should be noted that an inclination angle of a slant barrier is within 10 to 15 degrees with respect to the vertical direction and a center of a barrier aperture passes through a center of a sub-pixel at a position corresponding to a ratio between a vertical size and a horizontal size, as shown in the drawings.

Normally, with a slant barrier structure, moiré is reduced in accordance with an inclination angle of the barrier. However, since the aspect ratio of a pixel size is 3:1, there is a tendency that as the angle becomes steeper than 3:1, an area in which an adjacent pixel becomes visible widens to increase crosstalk. In the present embodiment, more favorably, CT is reduced by alternately arranging parallax images in sub-pixel units per two image rows and setting the aperture width to a vicinity of sub-pixel×1 to 2 to reduce moiré by the inclination angle of the barrier. The present embodiment represents this concept.

It should be noted that the inclination angle of the slant barrier is not limited to this. Any inclination angle may be adopted as long as the angle is within 10 to 15 degrees and an interval, at which the center of a barrier aperture matches a center of a sub-pixel, is a predetermined integral ratio (the interval when expressed by a ratio between a vertical size nv and a horizontal nh is an integral ratio). Normally, due to a relationship between a separating means and images displayed on a displaying means, images may be only arranged in sub-pixel units on the display means. Therefore, arranging images in arbitrary units that are smaller than sub-pixel units requires a conception such as associating one sub-pixel in one parallax image to several sub-pixels on the display means. With an inclination angle where a matching proportion between a center of a sub-pixel and a center of a barrier aperture is uneven and small, separation performance declines to increase crosstalk with reducing moiré since the aforementioned conception is necessary due to occurrence of locations where the relationship between arranged sub-pixels and apertures deviate significantly. In contrast, when a matching proportion between a center of a barrier aperture and a center of a sub-pixel is set to a predetermined integral ratio like the present invention, an increase in crosstalk may be suppressed because locations that require such a conception are eliminated or a number of such locations are reduced. It should be noted that with respect to the integral ratio nv:nh, it may appear that the smaller the interval, the better. However, since there is a risk of creating locations where the relationship between arranged sub-pixels and apertures abruptly deviate in a sub-pixel-unit arrangement, in order to suppress an abrupt variation in the sub-pixel arrangement, the wider the interval based on an integral ratio, the more gradual the variations.

Besides the pixel arrangement example according to the second embodiment in which parallax images are alternately arranged in sub-pixel units per two image rows, nn (nn>2) may alternatively be used.

In the present embodiment, a set of B+G+R of an adjacent viewpoint pixel becomes simultaneously visible when the observer moves slightly to the left or right like the first embodiment. Therefore, color moiré is less likely to occur and color balance at one viewpoint pixel is less likely to deteriorate.

It should be noted that although a case where a matching proportion between a center of a barrier aperture and a center of a sub-pixel is set to a predetermined integral ratio is described, when the separating means is lenticular, a matching proportion between a center of a lens and a center of a sub-pixel may be set to a predetermined integral ratio (the interval when expressed by a ratio between a vertical size nv and a horizontal nh is an integral ratio).

### <Other>

With the image display device according to the present invention described in the aforementioned embodiments, the image display means 100 which displays a parallax image may be a liquid crystal panel, which uses a backlight device, or a light-emitting PDP or organic EL panel and applied to any display means capable of displaying pixel rows of a parallax image.

Although the pixel arrangement, in which two image rows are extracted from parallax images and alternatively arranged, is mainly described, the present invention may be applied to a pixel arrangement in which more than two image rows nnn are extracted from parallax images and alternatively arranged. In this case, a ratio between a number of horizontal sub-pixels and a number of vertical pixels of a group of pixels corresponding to nn-number of viewpoints is not uniform. When an (average) aperture width is significantly smaller than the number nnn of extracted image rows×sub-pixel size like the case of the modification example 2 of the second embodiment (e.g. from sub-pixel size×the number of image rows×0.5 to sub-pixel size×the number of image rows×1.5), brightness of an image may decline significantly. Therefore, appropriate nnn suited to the device is favorably used.

Although head position detection based on a single camera image is described in the third or fourth embodiment, the head position detection may be combined with results of head position detection using two or more camera images. Except for usage of images, tracking may be performed using a time of flight (TOF) method in which a distance is measured by measuring a time TOF from irradiation of an object by illuminating light of an LED light source or alike to the return of reflected light or using a wired connection method which performs three-dimensional position measurement using electromagnetic force or alike. A tracking method, in which a predetermined test pattern is always displayed in a photograph of a viewer and a geometric measurement is performed on the basis of a size, a moiré variation of a pixel value or alike of the test pattern portion, may be used. Although position detection is based on the detection of the head of a person, an image of an entire person may be alternatively used if a region of a pupil or an eye is extracted and position detection is performed using the extraction result.

With arrangement control of pixel rows of parallax images in response to a position of the head, the arrangement of pixel rows may be controlled by performing real-time calculations using a CPU or a GPU. Otherwise, the arrangement of pixel rows may be selected from an LUT table prepared in advance.

In the example according to the first embodiment in which a barrier pattern is provided with a fine notched structure so that an aperture width periodically varies so as to be horizontally symmetrical, an adjustment range may be widened by adding variation parameters for a phase shift between left and right notched structures, a gap between notched structures and a maximum aperture width, like the modification of the second embodiment.

Although examples of a slant barrier or a diagonal step barrier is described for the first to fourth embodiments, the present invention may be applied to a case where a vertical striped barrier such as that described in the second prior art example is used.

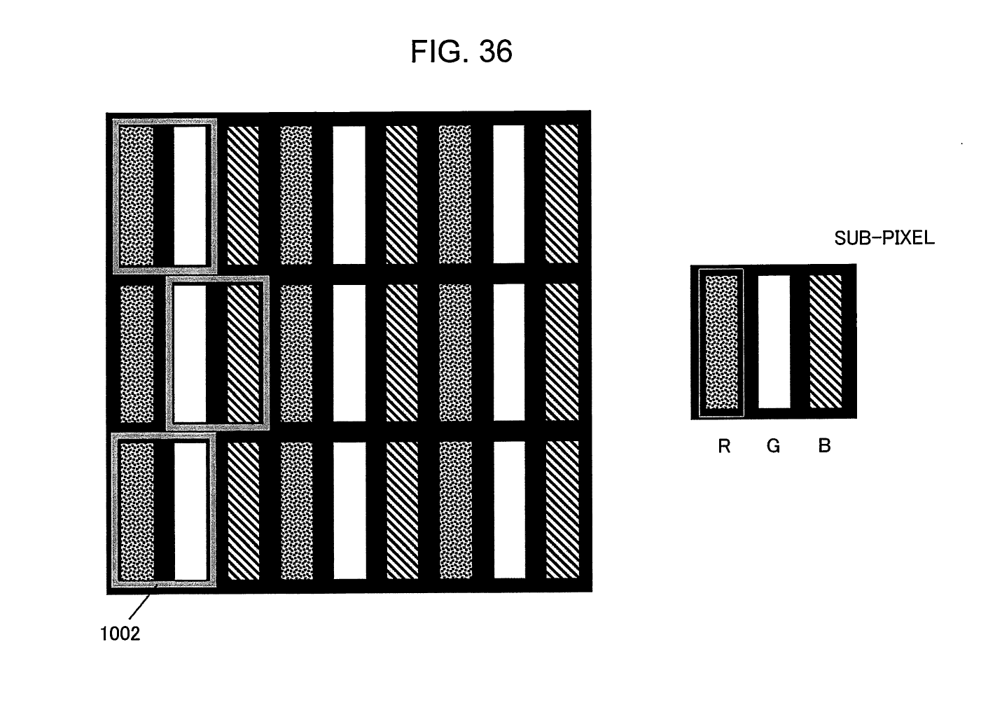

The present invention may be applied to a barrier pattern shape for suppressing leakage of light from a lens boundary in a lenticular system or to a barrier pattern shape having a vertical striped structure. As shown in FIG. 36, the present invention may be applied to a barrier pattern shape including rectangular apertures that are staggered every other row by one sub-pixel. As described above, the present invention may be applicable regardless of a shape or arrangement of apertures.

Although the present invention is described using a case where an aspect ratio of a sub-pixel size is 3:1 as an example, the present invention is not limited to any particular aspect ratio of a sub-pixel size and may be applied to a sub-pixel size other than 3:1. For example, when a sub-pixel has an aspect ratio of 5:1, an angle of a slant barrier or a step barrier is changed accordingly. The aspect ratio is 5:2 in the first embodiment and 5:1 in the second embodiment.

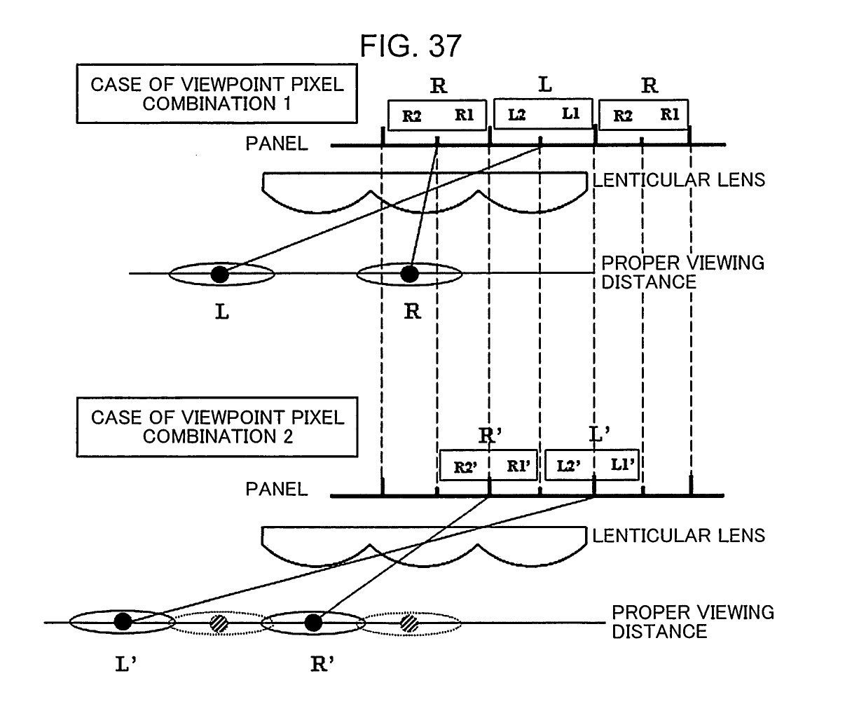

Although an example using a parallax barrier as the image separating means is described in the present invention, as shown in FIG. 37, the present invention may be applied to a case where a lenticular lens is used.

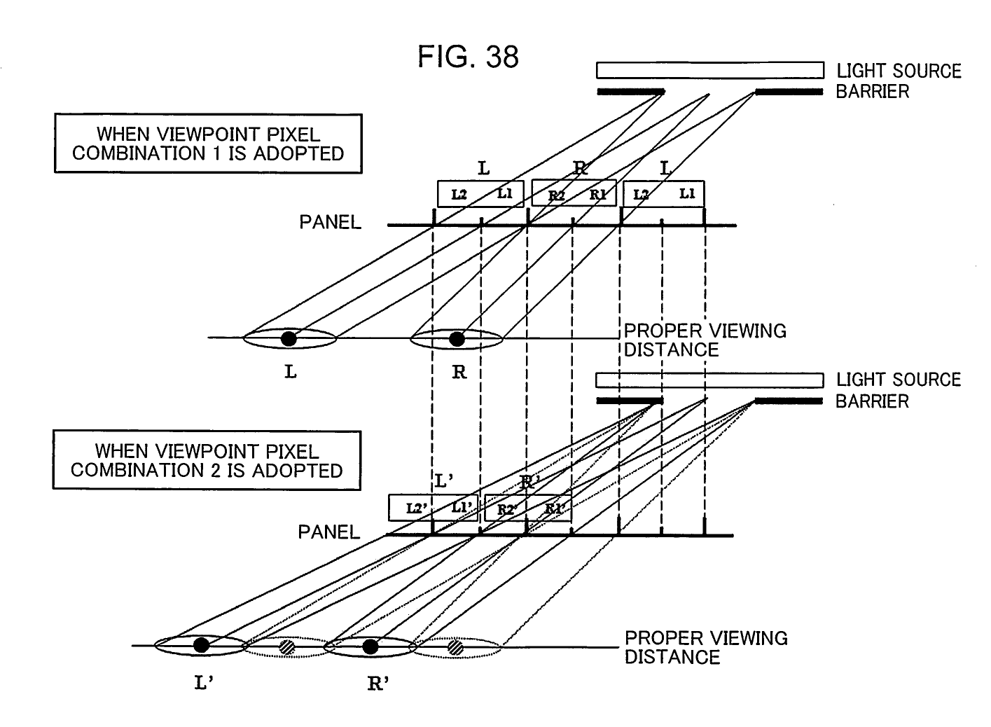

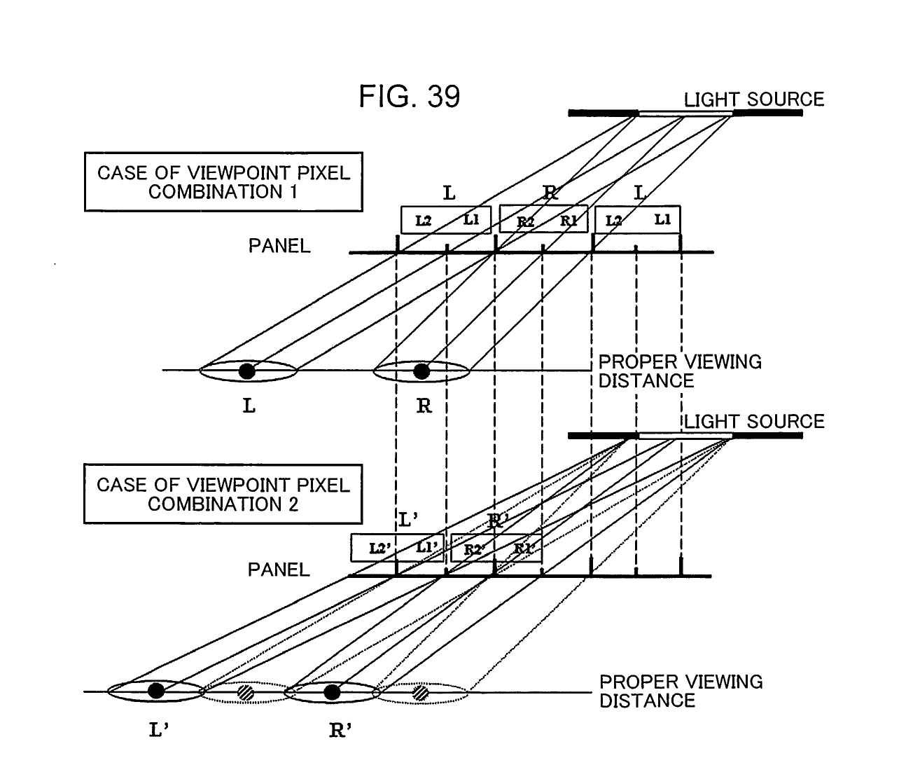

Although a system with the image separating means in front of the image display means is described in the present embodiment, a system in which a parallax barrier as the image separating means is arranged between a liquid crystal panel of a liquid crystal display and a backlight may be adopted as shown in FIG. 38. Instead of arranging a parallax barrier as the image separating means between a liquid crystal panel of a liquid crystal display and a backlight, a similar effect may be obtained by using a light source including a light emitter with a striped shape as shown in FIG. 39. It should be noted that a similar effect may be obtained by giving the light emitter of the light source the same shape in terms of a rectangular shape, a notched structure and alike as an aperture of the parallax barrier as the image separating means arranged between a liquid crystal panel of a liquid crystal display and a backlight.

With regard to the uneven portion (notch) structure according to the first to fourth embodiments, a notched structure may be added to a barrier aperture edge by providing a mechanism which determines a notch period so that adverse effects due to the notched structure itself do not occur. In particular, although the first to fourth embodiments are described on the basis of a notched structure having protrusions and recesses, similar effects are achieved even when the notched structure has a saw-tooth shape, a hog-backed shape, a stepped shape, a shape of a trigonometric function such as a sine function, a cosine function or a tangent function including a sine curve, a rectangular shape, a trapezoidal shape, a parallelogrammatic shape, a dog-leg shape or a crescent shape. Although a notched structure having protrusions and recesses in which heights or widths of the protrusions are not uniform (non-uniform) is described, this represents a state where protrusions with different heights or width coexist. Although a method for determining a notched structure based on a structure of a sub-pixel is described in the first to fourth embodiments, this method is not restrictive, and a notched structure has to be based only on a structure of a minimal unit that constitutes an image. For example, a notched structure may be based on a structure of a pixel constituted by several sub-pixels.

Although a system with the image separating means arranged in front of the image display means is described in the present embodiment, a system which has a parallax barrier as the image separating means arranged between a liquid crystal panel of a liquid crystal display and a backlight as shown in Fig. E may be adopted. Instead of arranging a parallax barrier as the image separating means between a liquid crystal panel of a liquid crystal display and a backlight, a similar effect may be obtained by using a light source including a light emitter with a striped shape as shown in Fig. F. It should be noted that a similar effect may be obtained by giving the light emitter of the light source the same shape in terms of a rectangular shape, a notched structure and alike as an aperture of the parallax barrier as the image separating means arranged between a liquid crystal panel of a liquid crystal display and a backlight.

Instead of arranging a parallax barrier as the image separating means, a light source including a light emitter with a striped shape may be used. In this case, by setting an inclination angle of the stripe light emitter in a range of 10 degrees to 15 degrees and adopting the pixel arrangement example in which parallax images are alternately arranged in sub-pixel units per two image rows on the display means, a similar effect to the fifth embodiment may be obtained.

The image display device described with reference to the various embodiments above has the following features.

A first image display device according to the present invention provides stereoscopic image display which arranges parallax images in sub-pixel units per two image rows and has a slant barrier aperture with an inclination of 3:2. The first invention is configured so that an amount/range of blur of pixels observed through a barrier may be controlled by providing a barrier pattern with a fine notched structure so that an aperture width periodically varies so as to be horizontally symmetrical and by adding irregularities to an aperture edge.

With the first image display device according to the present invention, by alternately arranging parallax images in sub-pixel units per two image rows, a proper viewing distance may be shortened and moiré may be reduced by widening an aperture up to a width corresponding to two sub-pixels. By providing a barrier pattern with a fine notched structure so that an aperture width periodically varies so as to be horizontally symmetrical, an average aperture ratio may be suppressed and moiré reduction may be achieved without increasing crosstalk.

A second image display device according to the present invention provides stereoscopic image display which arranges parallax images in sub-pixel units per two image rows and has a slant barrier aperture with an inclination of 3:1. The second invention is configured so that an amount/range of blur of pixels observed through a barrier may be controlled by providing a barrier pattern with a fine notched structure so that an aperture width periodically varies so as to be horizontally symmetrical and by adding irregularities to an aperture edge. In an alternative invention, an adjustment range is widened by adding variation parameters for a phase shift between left and right notched structures, a gap between the notched structures, and a maximum aperture width.

Like the second image display device according to the present invention, by alternately arranging parallax images in sub-pixel units per two image rows and providing a slant barrier aperture with an inclination of 3:1, a proper viewing distance may be shortened and crosstalk may be more suppressed than the first embodiment. By providing the barrier pattern with a fine notched structure so that an aperture width periodically varies so as to be horizontally symmetrical, moiré may be further suppressed without increasing an average aperture ratio. By controlling the aperture width size so as not to exceed two sub-pixels (e.g. between 1 sub-pixel to 1.5 sub-pixels), crosstalk may be significantly reduced. By providing the barrier pattern with a fine notched structure, moiré reduction may be achieved.

A third image display device according to the present invention provides stereoscopic image display which changes an alternate arrangement combination of image rows extracted from each parallax image in response to a viewer position obtained from a position detecting means configured to detect a position of the head or eyes of a viewer, in addition to the first or second invention.

Like the third image display device according to the present invention, by providing a function for changing an alternate arrangement combination of image rows extracted from each parallax image in response to a viewer position obtained from the position detecting means configured to detect a position of the head or eyes of a viewer in addition to the first or second invention, distortion of fusion due to head movement may be improved in addition to an effect similar to the first or second invention.

A fourth image display device according to the present invention provides a stereoscopic image display device which changes an alternate arrangement combination of image rows extracted from each parallax image in response to a viewer position obtained from a position detecting means configured to detect a position of the head or eyes of a viewer and form an aperture shape by controlling transmittance of a region allowing variable control of light transmittance in accordance with an inclination angle formed by the image rows and a width of the image rows of each of the arranged parallax images, in addition to the first or second invention.

The fourth image display device according to the present invention changes an alternate arrangement combination of image rows extracted from each parallax image in response to a viewer position obtained from the position detecting means configured to detect a position of the head or eyes of a viewer and form an aperture shape by controlling transmittance of a region in which light transmittance may be variably controlled in accordance with an inclination angle formed by the image rows and a width of the image rows of each of the arranged parallax images, in addition to the first or second invention. Therefore, the fourth image display device according to the present invention is capable of improving distortion of fusion due to head movement in addition to an effect similar to the first or second invention. By adjusting the aperture width more freely, the difficulty of fusion due to head movement may be more improved than merely changing combinations of pixel arrangements like the third invention.

A fifth image display device according to the present invention provides stereoscopic image display which alternately arranges parallax images in sub-pixel units per two image rows according to the first embodiment and has a slant barrier aperture with an inclination of any of 15:3 (an inclination of 11.3 degrees with respect to the vertical direction), 9:2 (an inclination of 12.52 degrees with respect to the vertical direction), 21:5 (an inclination of 13.39 degrees with respect to the vertical direction), 4:1 (an inclination of 14.04 degrees with respect to the vertical direction), 27.7 (an inclination of 14.53 degrees with respect to the vertical direction), and 15:4 (an inclination of 14.93 degrees with respect to the vertical direction). The second invention is configured so that an amount/range of blur of pixels observed through a barrier may be controlled by providing a barrier pattern with a fine notched structure so that an aperture width periodically varies so as to be horizontally symmetrical and by adding irregularities to an aperture edge.

### INDUSTRIAL APPLICABILITY

According to the present invention, a barrier pattern capable of reducing moiré without increasing crosstalk and capable of shortening a proper viewing distance may be realized. Also, an image display device including the barrier pattern may be provided. The present invention may provide image display that is particularly effective in devices with relatively small sizes such as mobile/tablet devices.

What is claimed is:

1. An image display device comprising:
an image display means which displays a composite image of rows of pixels selected and arranged from parallax images; and
an image separating means which is arranged at a predetermined distance from the image display means to separate image information from each of the parallax images included in an image displayed by the image display means so that the image information is observed at a predetermined position, wherein
image rows extracted from each of the parallax images are alternately arranged, and
an aperture shape is formed in accordance with inclination angles formed by the arranged image rows and widths of the image rows of each of the parallax images.

2. An image display device comprising:
an image display means which displays a composite image of rows of pixels selected and arranged from parallax images; and
an image separating means which is arranged at a predetermined distance from the image display means to separate image information from each of the parallax images included in an image displayed by the image display means so that the image information is observed at a predetermined position, wherein
image rows extracted from each of the parallax images are alternately arranged,
an aperture shape is formed in accordance with inclination angles formed by the arranged image rows and widths of the image rows of each of the parallax images, and
an aperture shape is formed so as to control an amount/range of blur of pixels observed through a barrier aperture by adding irregularities to the aperture shape.

3. An image display device comprising:
an image display means which displays a composite image of rows of pixels selected and arranged from parallax images; and
an image separating means which is arranged at a predetermined distance from the image display means to separate image information from each of the parallax images included in an image displayed by the image display means so that the image information is observed at a predetermined position, wherein
image rows extracted from each of the parallax images are alternately arranged, and
an aperture shape which has a smaller width than widths of the image rows is formed in accordance with inclination angles formed by the arranged image rows of each of the parallax images.

4. An image display device comprising:
an image display means which displays a composite image of rows of pixels selected and arranged from parallax images; and
an image separating means which is arranged at a predetermined distance from the image display means to separate image information from each of the parallax images included in an image displayed by the image display means so that the image information is observed at a predetermined position, wherein
image rows extracted from each of the parallax images are alternately arranged,
an aperture shape which has a smaller width than widths of the image rows is formed in accordance with inclination angles formed by the arranged image rows of each of the parallax images, and
the aperture shape is formed so as to control an amount/range of blur of pixels observed through a barrier aperture by adding irregularities to the aperture shape.

5. An image display device comprising:
an image display means which displays a composite image of rows of pixels selected and arranged from parallax images;
an image separating means which is arranged at a predetermined distance from the image display means to separate image information from each of the parallax images included in an image displayed by the image display means so that the image information is observed at a predetermined position; and
a position detecting means which detects a position of a head or an eye of a viewer, wherein
image rows extracted from each of the parallax images are alternately arranged in accordance with a viewer position, and
an aperture shape is formed in accordance with inclination angles formed by the arranged image rows and widths of the image rows of each of the parallax images.

6. An image display device comprising:
an image display means which displays a composite image of rows of pixels selected and arranged from parallax images;
an image separating means which is arranged at a predetermined distance from the image display means to separate image information from each of parallax images included in an image displayed by the image display means so that the image information is observed at a predetermined position; and
a position detecting means which detects a position of a head or an eye of a viewer, wherein
image rows extracted from each of the parallax images are alternately arranged in accordance with a viewer position,
an aperture shape is formed in accordance with inclination angles formed by the arranged image rows and widths of the image rows of each of the parallax images, and
the aperture shape is formed so as to control an amount/range of blur of pixels observed through a barrier aperture by adding irregularities to the aperture shape.

7. An image display device comprising:
an image display means which displays a composite image of rows of pixels selected and arranged from parallax images;
an image separating means which is arranged at a predetermined distance from the image display means to separate image information from each of the parallax images included in an image displayed by the image display means so that the image information is observed at a predetermined position; and
a position detecting means which detects a position of a head or an eye of a viewer, wherein
image rows extracted from each of the parallax images are alternately arranged in accordance with a viewer position, and
an aperture shape which has a smaller width than widths of the image rows is formed in accordance with inclination angles formed by the arranged image rows of each of the parallax images.

8. An image display device comprising:
an image display means which displays a composite image of rows of pixels selected and arranged from parallax images;
an image separating means which is arranged at a predetermined distance from the image display means to separate image information from each of the parallax images included in an image displayed by the image display means so that the image information is observed at a predetermined position; and
a position detecting means which detects a position of a head or an eye of a viewer, wherein
image rows extracted from each of the parallax images are alternately arranged in accordance with a viewer position,
an aperture shape which has a smaller width than widths of the image rows is formed in accordance with inclination angles formed by the arranged image rows of each of the parallax images, and
the aperture shape is formed so as to control an amount/range of blur of pixels observed through a barrier aperture by adding irregularities to the aperture shape.

9. An image display device comprising:
an image display means which displays a composite image of rows of pixels selected and arranged from parallax images;
an image separating means which is arranged at a predetermined distance from the image display means to separate image information from each of the parallax images included in an image displayed by the image display means so that the image information is observed at a predetermined position; and
a position detecting means which detects a position of a head or an eye of a viewer, wherein
image rows extracted from each of the parallax images are alternately arranged in accordance with a viewer position, and
an aperture shape is formed in accordance with inclination angles formed by the arranged image rows and widths of the image rows of each of the parallax images by controlling light transmittance of a region in which the light transmittance is variably controlled.

10. An image display device comprising:
an image display means which displays a composite image of rows of pixels selected and arranged from parallax images;
an image separating means which is arranged at a predetermined distance from the image display means to separate image information from each of the parallax images included in an image displayed by the image display means so that the image information is observed at a predetermined position; and
a position detecting means which detects a position of a head or an eye of a viewer, wherein
image rows extracted from each of the parallax images are alternately arranged in accordance with a viewer position,
an aperture shape is formed in accordance with inclination angles formed by the arranged image rows and widths of the image rows of each of the parallax images by controlling light transmittance of a region in which the light transmittance is variably controlled, and
the aperture shape is formed so as to control an amount/range of blur of pixels observed through a barrier aperture by adding irregularities to the aperture shape.

11. An image display device comprising:
an image display means which displays a composite image of rows of pixels selected and arranged from parallax images;
an image separating means which is arranged at a predetermined distance from the image display means to separate image information from each of the parallax images included in an image displayed by the image display means so that the image information is observed at a predetermined position; and
a position detecting means which detects a position of a head or an eye of a viewer, wherein
image rows extracted from each of the parallax images are alternately arranged in accordance with a viewer position, and
an aperture shape which has a smaller width than widths of the image rows is formed in accordance with inclination angles formed by the arranged image rows of each of the parallax images by controlling light transmittance of a region in which the light transmittance is variably controlled.

12. An image display device comprising:
an image display means which displays a composite image of rows of pixels selected and arranged from parallax images;
an image separating means which is arranged at a predetermined distance from the image display means to separate image information from each of the parallax images included in an image displayed by the image display means so that the image information is observed at a predetermined position; and
a position detecting means which detects a position of a head or an eye of a viewer, wherein
image rows extracted from each of the parallax images are alternately arranged in accordance with a viewer position,
an aperture shape which has a smaller width than widths of the image rows is formed in accordance with inclination angles formed by the arranged image rows of each of the parallax images by controlling light transmittance of a region in which the light transmittance is variably controlled, and
the aperture shape is formed so as to control an amount/range of blur of pixels observed through a barrier aperture by adding irregularities to the aperture shape.

13. The image display device according to claim 1, wherein
the arranged image rows of each of the parallax images forms an angle of 10 to 15 degrees with respect to a vertical direction.
